(19) United States
(12) Patent Application Publication
(10) Pub. No.: US 2026/0358206 A1
(43) Pub. Date: Nov. 12, 2026

(54) Method, Apparatus, and System for Specimen Flattening

(71) Applicant: niversity of Rochester, Rochester, NY (US)

(72) Inventors: Michael Giacomelli, Rochester, NY (US); Vincent Ching-Roa, Rochester, NY (US); Chi Huang, Rochester, NY (US); Connor Heckman, Rochester, NY (US); Sherrif Ibrahim, Rochester, NY (US)

(21) Appl. No.: 19/421,652

(22) Filed: Dec. 16, 2025

Related U.S. Application Data
(60) Provisional application No. 63/736,914, filed on Dec. 20, 2024.

(51) Int. Cl. G01N 1/28

(52) U.S. Cl. CPC G01N 1/286

(57) ABSTRACT

A specimen flattening apparatus is described. The apparatus includes a base comprising a bottom floor. The bottom floor also includes a flat compression surface configured to support a specimen. The apparatus also includes a primary lid having a flexible membrane and a perimeter. The primary lid is removably attached to the base via sealingly contacting the perimeter to the base such that the flexible membrane is opposite the flat compression surface, thereby forming a vacuum chamber bounded by the primary lid and the base. The apparatus also includes at least one vacuum pump connected to the vacuum chamber.

### CROSS-REFERENCE TO RELATED APPLICATIONS

This application claims priority to U.S. Provisional Application No. 63/736,914 filed on Dec. 20, 2024 incorporated by reference herein in its entirety.

### FEDERALLY SPONSORED RESEARCH AND DEVELOPMENT

This invention was made with government support under CA258376 awarded by the National Institutes of Health. The government has certain rights in the invention.

### FIELD

The present disclosure generally relates to the field of medical devices and histopathology.

### BACKGROUND OF THE INVENTION

Removal of tissue from the body is commonly performed to diagnose disease or treat conditions such as cancer. In these procedures, a volume of tissue is extracted and then typically submitted for histological processing. During processing, the tissue is cut into thin sections which can be stained with absorptive dye. Immunohistochemistry or other assays can also be performed on the thin sections of tissue. These sections are mounted on slides and interpreted by a pathologist or other medical professional who then renders a diagnosis, confirms efficacy of treatment or otherwise guides therapy.

A common challenge in histological processing of tissue is to extract a single, flat 2D plane from an irregularly shaped 3D specimen. One approach is to embed the tissue into a solid media such as paraffin or cryosectioning media and then cut away the surface of the tissue until a flat plane is obtained covering the entire surface. Provided the cut away tissue is not of interest, this approach can be used to create a histology slide from deep inside the tissue.

However, in many scenarios it is undesirable to discard parts of the specimen. For example, the goal may be to assess the tissue surface for the presence of cancer, and cutting away that surface may change the patient's diagnosis or treatment. In this case the tissue must be flattened without cutting using a combination of relaxing incisions into the tissue, mechanical compression, and careful cutting of superficial sections from the surface. Extensive experience is required to perform this process, and errors can negatively affect patient treatment, if, for example, tissue is insufficiently flattened and the diagnostic tissue of interest must be cut away.

In many instances rapid diagnosis of a subject is required or desired which may lead to challenges. In many surgeries, excised tissues are rapidly frozen and sections cut from the surface to determine if cancer has been completely removed while the patient waits mid-surgery. In this case, a histotechnician must rapidly flatten and freeze the tissue, with delays resulting in extended surgical procedures. For example, during Mohs surgery for skin cancer, excised tissue must be flattened as much as possible and then cryosectioned while the patient waits in surgery. The surgeon then evaluates the histology slides for the presence of residual disease which can be further excised. Even with careful preparation of the sample, the final cutting plane may be several hundred micrometers or more below the true tissue surface, creating a risk that the technician cuts into the tumor, resulting in a false positive and incorrect patient treatment.

Roughly 1 million patients per year are treated for skin cancer using Mohr's surgery. Conventional Mohs surgery for skin and other cancers extracts tissue from the patient, carefully flattens and freezes the tissue and then cuts into thin sections which can be mounted on a slide and visualized with a microscope. An alternative approach is to image the tissue without freezing which is dramatically quicker but can be challenging as the tissue will be irregularly shaped and thus difficult to produce a single, flat image.

Alternatively, some methods such as optical coherence tomography (OCT) or fluorescence imaging attempt to detect residual disease on the tissue surface without freezing or sectioning of the tissue. In these scenarios, lack of flatness can result in areas of the tissue surface being obscured by folds or out of focus, resulting in incomplete evaluation of the tissue surface. While tissue is not physically lost, failure to completely evaluate it can still negatively affect the patient's treatment.

Various methods and devices have been proposed that can flatten tissue more completely and so reduce errors. These include elaborate dissection and incision techniques that aim to mechanically reshape the tissue. While potentially effective, these methods are highly operator and context dependent, time-consuming, and introduce risk that the tissue may be damaged if incisions are too deep or too extensive. Mechanical devices such as compressive lids and balloon compression holders have also been demonstrated that mechanically, pneumatically or hydraulically transmit a positive pressure to the tissue surface, forcing it downwards onto a flat glass or metal surface.

While these can flatten the tissue, since the force is applied directly downwards, they can also introduce folds into the tissue, resulting in part of the specimen face being obscured. These devices also struggle with fluid and air becoming trapped under the tissue surface, resulting in the need for impractically high forces to get a completely flat surface. These devices are further problematic when combined with optical imaging such as OCT or fluorescence microscopy because the tissue must be mounted on a thin glass plate which can withstand limited force before deflecting or breaking. Another disadvantage of these methods is that once the tissue is compressed, it is inaccessible and any folds or other issues cannot easily be corrected.

There remains a need in the art for methods, devices, and systems that can flatten a variety of specimens for imaging techniques. The present invention satisfies this unmet need.

### SUMMARY OF THE INVENTION

In some aspects the invention relates to a specimen flattening apparatus. In some embodiments, the specimen flattening apparatus comprises a base comprising a bottom floor comprising a flat compression surface configured to support a specimen, a primary lid comprising a flexible membrane and a perimeter, wherein the primary lid is removably attached to the base via sealingly contacting the perimeter to the base such that the flexible membrane is opposite the flat compression surface, thereby forming a primary vacuum chamber bounded by the primary lid and the base, and at least one vacuum pump connected to the primary vacuum chamber.

In some embodiments, the apparatus also includes a secondary lid comprising a top surface and a bottom opening forming a secondary cavity, wherein the secondary lid is removably attached to the base enclosing the primary lid forming a seal at the bottom opening such that the secondary cavity forms a secondary vacuum chamber, and wherein the flexible membrane forms at least part of a boundary between the primary vacuum chamber and the secondary vacuum chamber, and at least one vacuum pump connected to the secondary vacuum chamber.

In some embodiments, the primary lid of the apparatus further comprises an enclosed cavity that forms a secondary vacuum chamber, the flexible membrane forms at least part of the boundary between the primary vacuum chamber and the secondary vacuum chamber, and the apparatus further comprises at least one vacuum pump connected to the secondary vacuum chamber.

In some embodiments, the base and the primary lid of the apparatus are enclosed within a secondary vacuum chamber, wherein the secondary vacuum chamber includes a sealable opening.

In some embodiments, the base of the apparatus also includes a vacuum port fluidly connected to the primary vacuum chamber.

In some embodiments, the primary lid of the apparatus also includes a retainer.

In some embodiments, the primary vacuum and the secondary vacuum chamber of the apparatus are fluidly connected though at least one port.

In some embodiments, the apparatus includes a specimen positioned in the primary vacuum chamber on the flat compression surface.

In some embodiments, the specimen positioned in the apparatus is selected from one or more of the group consisting of: a tissue, a biopsy, a tumor, a shave specimen, an excision, a surgical margin, an animal specimen, and other surgically or diagnostically removed tissue or histology.

In some embodiments, the apparatus includes a fluid wicking liner positioned in the primary vacuum chamber.

In some embodiments, the fluid wicking liner of the apparatus comprises a material selected from the group consisting of: a fibrous material, cellulose or paper, synthetic or plastic wick, cotton, and other water permeable material.

In some embodiments, the flat compression surface of the apparatus has a greater surface area than the flexible membrane.

In some embodiments, the flat compression surface of the apparatus is at least partially optically transparent.

In some embodiments, the flexible membrane of the apparatus is at least partially optically transparent.

In some embodiments, the flat compression surface of the apparatus is thermally conductive.

In some embodiments, the flat compression surface of the apparatus is comprised of a material selected from the group consisting of: a metal, a glass, a plastic, a crystal, calcium fluoride glass, magnesium fluoride glass, and borosilicate glass.

In some embodiments, the flexible membrane of the apparatus is comprised of a material selected from the group consisting of: rubber, silicone, latex, and plastic.

In some embodiments, the apparatus includes a microscope or a camera configured to image at least a portion of the cavity.

In some embodiments, the microscope or camera of the apparatus is positioned to examine the specimen through the flat compression surface.

In some embodiments, the apparatus includes a specimen divider extending into the primary vacuum chamber from the flat compression surface.

In some embodiments, the apparatus includes a reservoir or port connected to the primary vacuum chamber configured to introduce fluid to the primary vacuum chamber. In some embodiments, the fluid introduced to the primary vacuum chamber comprises a component selected from the group consisting of: a fixing solution, formalin, formaldehyde, paraformaldehyde, methanol, a buffer, saline, a permeabilization solution, a detergent, an antibody, a fluorescent molecule, an imaging stain, DAPI, Hoechst, acridine, eosin, DNA stain, and protein stain.

In some embodiments, the apparatus includes a pressure valve connected to the primary vacuum chamber.

In some embodiments, the apparatus includes a pressure valve connected to the secondary vacuum chamber.

In some embodiments, the apparatus includes a temperature control component selected from the group consisting of: an external heat extractor, an internal heat extractor, and a thermoelectric cooler.

In some embodiments, the primary vacuum chamber of the apparatus is configured to withstand a pressure difference selected from the group consisting of: about O atmospheres, about 0.1 atmospheres, about 0.2 atmospheres, about 0.3 atmospheres, about 0.4 atmospheres, about 0.5 atmospheres, about 0.6 atmospheres, about 0.7 atmospheres, about 0.8 atmospheres, about 0.9 atmospheres, and about 1 atmosphere.

In some embodiments, the primary and secondary vacuum chambers of the apparatus are configured to withstand a pressure difference selected from the group consisting of: about 0 atmospheres, about 0.1 atmospheres, about 0.2 atmospheres, about 0.3 atmospheres, about 0.4 atmospheres, about 0.5 atmospheres, about 0.6 atmospheres, about 0.7 atmospheres, about 0.8 atmospheres, about 0.9 atmospheres, and about 1 atmosphere.

In some embodiments, a processor is communicatively connected to the apparatus.

In some embodiments, one or more of the valves of the apparatus are control valves communicatively connected to a processor.

In some embodiments, the at least one vacuum pump of the apparatus is communicatively connected to a processor.

In some aspects, the invention relates to a method of flattening a specimen. In some embodiments, the method includes the steps of: providing a vacuum apparatus comprising a flat compression surface, a flexible membrane opposite the flat compression surface, and a primary vacuum chamber therebetween the flat compression surface and the flexible membrane, providing at least one specimen, positioning the at least one specimen in the primary vacuum chamber on the flat compression surface, and depressurizing the primary vacuum chamber.

In some embodiments of the method, the vacuum apparatus also includes a secondary vacuum chamber, wherein the flexible membrane comprises at least part of a boundary between the primary vacuum chamber and the secondary vacuum chamber.

In some embodiments, the method includes the steps of depressurizing the primary and secondary vacuum chambers; and equalizing the pressure of the secondary vacuum chamber with atmosphere.

In some embodiments, the method includes the step of manipulating the at least one specimen through the flexible membrane to enhance uniform flattening of the at least one specimen or to reveal obscured facets of the at least one specimen.

In some embodiments, the method includes the step of removing at least some liquid from the primary vacuum chamber.

In some embodiments, the method includes the step of fixing the specimen.

In some embodiments, the method includes the step of introducing a fluid to the primary vacuum chamber.

In some embodiments of the method, the fluid introduced to the primary vacuum chamber comprises a component selected from the group consisting of: a fixing solution, formalin, formaldehyde, paraformaldehyde, methanol, a buffer, saline, a permeabilization solution, a detergent, an antibody, a fluorescent molecule, an imaging stain, DAPI, Hoechst, acridine, eosin, DNA stain, and protein stain.

In some embodiments of the method, the specimen positioned in the primary vacuum chamber is selected from the group consisting of: a tissue, a biopsy, a tumor, a shave specimen, an excision, a surgical margin, an animal specimen, and other surgically or diagnostically removed tissue or histology.

In some embodiments of the method, the depressurization of the primary chamber is sufficient to achieve a pressure within the primary vacuum chamber of at least less than 1 atmosphere, 0.9 atmospheres, 0.8 atmospheres, 0.7 atmospheres, 0.6 atmospheres, 0.5 atmospheres, 0.4 atmospheres, 0.3 atmospheres, 0.2 atmospheres, 0.1 atmospheres, 0.05 atmospheres, or less than 0.05 atmospheres.

In some embodiments of the method, the depressurization of the primary chamber and secondary vacuum chambers is sufficient to achieve a pressure within the primary and secondary vacuum chambers of at least less than: 1 atmosphere, 0.9 atmospheres, 0.8 atmospheres, 0.7 atmospheres, 0.6 atmospheres, 0.5 atmospheres, 0.4 atmospheres, 0.3 atmospheres, 0.2 atmospheres, 0.1 atmospheres, 0.05 atmospheres, or less than 0.05 atmospheres.

In some embodiments, the method includes the step of cooling the apparatus to sufficiently freeze the positioned specimen.

In some embodiments, the method includes the steps of removing the specimen from the primary vacuum chamber, and sectioning the specimen.

In some aspects, the invention relates to a method of diagnosing a subject. In some embodiments, the method includes the steps of obtaining at least one specimen from a subject, providing a vacuum apparatus comprising a flat compression surface, a flexible membrane opposite the flat compression surface, and a primary vacuum chamber therebetween the flat compression surface and the flexible membrane, placing the at least one specimen in the primary vacuum chamber on the flat compression surface of the apparatus, depressurizing the primary vacuum chamber of the apparatus, examining the specimen, and diagnosing the subject based on the examination of the specimen.

In some aspects, the invention relates to a method of performing a surgery. In some embodiments, the method includes the steps of obtaining at least one sample of a tissue of a subject during a surgical procedure, providing a vacuum apparatus comprising a flat compression surface, a flexible membrane opposite the flat compression surface, and a primary vacuum chamber therebetween the flat compression surface and the flexible membrane, placing the at least one sample in the primary vacuum chamber on the flat compression surface of the apparatus, depressurizing the primary vacuum chamber of the apparatus, examining the specimen, and removing tissue from the subject based on the examination of the specimen.

In some aspects, the invention relates to a system for flattening at least one specimen. In some embodiments, the system includes a vacuum apparatus comprising a flat compression surface, a flexible membrane opposite the flat compression surface, and a primary vacuum chamber therebetween the flat compression surface and the flexible membrane, wherein the primary vacuum chamber is configured to hold the at least one specimen, a display, a processor communicatively connected to the vacuum apparatus and the display, and a non-transitory computer readable medium with instructions stored thereon, which when executed by a processor perform steps comprising: depressurizing the primary vacuum chamber of the apparatus.

In some embodiments, the vacuum apparatus of the system also includes a secondary vacuum chamber, wherein the flexible membrane forms at least part of a boundary between the primary vacuum chamber and the secondary vacuum chamber.

In some embodiments, the non-transitory computer readable medium of the system includes instructions stored thereon which when executed by the processor performs steps comprising: depressurizing the primary vacuum chamber of the apparatus, and equalizing the pressure of the secondary vacuum chamber with atmosphere.

In some embodiments, the non-transitory computer readable medium of the system includes instructions stored thereon which when executed by the processor performs steps comprising: removing at least some liquid from the primary vacuum chamber.

In some embodiments, the non-transitory computer readable medium of the system includes instructions stored thereon which when executed by the processor performs steps comprising: introducing a fluid to the primary vacuum chamber.

In some embodiments of the system, the fluid introduced to the primary vacuum chamber comprises a component selected from the group consisting of: a fixing solution, formalin, formaldehyde, paraformaldehyde, methanol, a buffer, saline, a permeabilization solution, a detergent, an antibody, a fluorescent molecule, an imaging stain, DAPI, Hoechst, acridine, eosin, DNA stain, and protein stain.

In some embodiments of the system, the specimen is selected from one or more of the group consisting of: a tissue, a biopsy, a tumor, a shave specimen, an excision, a surgical margin, an animal specimen, and other surgically or diagnostically removed tissue or histology.

In some embodiments of the system, depressurization of the primary chamber is sufficient to achieve a pressure within the primary vacuum chamber of at least less than 1 atmosphere, 0.9 atmospheres, 0.8 atmospheres, 0.7 atmospheres, 0.6 atmospheres, 0.5 atmospheres, 0.4 atmospheres, 0.3 atmospheres, 0.2 atmospheres, 0.1 atmospheres, 0.05 atmospheres, or less than 0.05 atmospheres.

In some embodiments of the system, the depressurization of the primary chamber and secondary vacuum chambers is sufficient to achieve a pressure within the primary and secondary vacuum chambers of at least less than: 1 atmosphere, 0.9 atmospheres, 0.8 atmospheres, 0.7 atmospheres, 0.6 atmospheres, 0.5 atmospheres, 0.4 atmospheres, 0.3 atmospheres, 0.2 atmospheres, 0.1 atmospheres, 0.05 atmospheres, or less than 0.05 atmospheres.

In some embodiments, the non-transitory computer readable medium of the system includes instructions stored thereon which when executed by the processor performs steps comprising: cooling the apparatus to sufficiently freeze the at least one specimen.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1 depicts an exemplary embodiment of a specimen flattening apparatus that includes a single vacuum chamber in which the removable lid of the apparatus is applied.

FIG. 2 depicts an exemplary embodiment of a specimen flattening apparatus that includes a single vacuum chamber in which the removable lid of the apparatus is opened.

FIG. 3 depicts an exemplary embodiment of a specimen flattening apparatus that includes a single vacuum chamber and a fluid wicking liner.

FIG. 4 depicts an exemplary embodiment of a specimen flattening apparatus that includes a single vacuum chamber and expansion spaces.

FIG. 5 depicts an exemplary embodiment of a specimen flattening apparatus that includes a single vacuum chamber, a lid, and a flexible membrane that is separated from the lid.

FIG. 6 depicts an exemplary embodiment of a specimen flattening apparatus that includes multiple specimens.

FIG. 7 depicts an exemplary embodiment of a specimen flattening apparatus that includes two vacuum chambers in which two removable lids of the apparatus are applied.

FIG. 8 depicts an exemplary embodiment of a specimen flattening apparatus that includes two vacuum chambers in which two removable lids of the apparatus are opened.

FIG. 9 depicts an exemplary embodiment of a specimen flattening apparatus that includes two vacuum chambers and an atmospheric valve.

FIG. 10 depicts an exemplary embodiment of a specimen flattening apparatus that includes two vacuum chambers and a single removable lid.

FIG. 11 depicts an exemplary embodiment of a method for flattening a specimen with an apparatus that includes a single vacuum chamber.

FIG. 12 depicts an exemplary embodiment of a method for flattening a specimen with an apparatus that includes two vacuum chambers.

FIG. 13 depicts an exemplary embodiment of a method for flattening a specimen.

FIG. 14 depicts an exemplary embodiment of a method for performing a surgery.

FIG. 15 depicts an exemplary computing environment in accordance with some of the embodiments.

FIG. 16 depicts a top view of an exemplary embodiment of an apparatus for flattening a specimen that includes one vacuum chamber.

FIG. 17 depicts an oblique view of an exemplary embodiment of an apparatus for flattening a specimen that includes two vacuum chambers and two lids in which both lids are applied.

FIG. 18 depicts an oblique view of an exemplary embodiment of an apparatus for flattening a specimen that includes two vacuum chambers and two lids in which the primary lid is applied and the secondary lid is removed.

FIG. 19 depicts a top view of an exemplary embodiment of an apparatus for flattening a specimen containing a flattened specimen that includes two vacuum chambers in which the secondary removable lid of the apparatus is removed, and a flattened specimen.

FIG. 20 depicts a top view of an exemplary embodiment of an apparatus for flattening larger specimens including one vacuum chamber containing a flattened specimen.

### DETAILED DESCRIPTION

The following discussion omits or only briefly describes conventional features of methods, apparatuses, and systems for flattening a specimen that are apparent to those skilled in the art. Those of ordinary skill may thus recognize that other elements may be desirable and/or necessary to implement the devices, systems, and methods described herein. It is noted that various examples are described in detail with reference to the drawings. Reference to these various examples does not limit the scope of the claims attached hereto. Additionally, any examples set forth in this specification are intended to be non-limiting and merely set forth some of the many possible implementations for the appended claims. Further, particular features described herein can be used in combination with other described features in each of the various possible combinations and permutations. As such, it is understood that the detailed description is exemplary and explanatory only and is not restrictive of the broad inventive concepts upon which the examples disclosed herein are based.

Unless otherwise specifically defined herein, all terms are to be given their broadest reasonable interpretation. This includes meanings implied from the specification as well as meanings understood by those skilled in the art and/or as defined in dictionaries, treatises, etc.

It is noted that, as used in the specification and the appended claims, the singular forms “a,” “an” and “the” include plural referents unless otherwise specified. The terms “includes” and/or “including,” when used in this specification, specify the presence of stated features, elements, and/or components, but do not preclude the presence or addition of one or more other features, steps, operations, elements, components, and/or groups thereof.

Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then-described or as shown in the drawing figure under discussion. These relative terms are for convenience of description and normally are not intended to require a particular orientation in actuality. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The phrases “operatively” or “operably connected” indicates such an attachment, coupling or connection that allows the pertinent structures to operate as intended by virtue of that relationship.

Reference throughout the specification to “exemplary”, “one example”, “an example” or “some examples” means that a particular feature, structure, or characteristic described in connection with at least one example of the subject matter disclosed. Thus, the appearance of the phrases “in one example”, “in an example” or “in some examples” in various places throughout the specification is not necessarily referring to the same example. Further, the particular features, structures or characteristics of “one example”, “an example” or “some examples” may be combined in any suitable manner with each other to form additional examples of such combinations. It is intended that examples of the disclosed subject matter cover modifications and variations thereof. Terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Moreover, throughout this disclosure, various aspects can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range. As used herein, the term “about” in reference to a measurable value, such as an amount, a temporal duration, and the like, is meant to encompass variations of plus or minus 20%, plus or minus 10%, plus or minus 5%, plus or minus 1%, and plus or minus 0.1% of the specified value, as such variations are appropriate.

The terms “proximal,” “distal,” “anterior,” “posterior,” “medial,” “lateral,” “superior,” and “inferior” are defined by their standard usage indicating a directional term of reference. For example, “proximal” refers to a position that is situated nearer to the center of a body or point of attachment or interest, while “distal” refers to a position that is situated away from the center of the body or point of attachment or interest. In another example, “anterior” refers to the front of a body or structure, while “posterior” refers to the rear of a body or structure, in relation to a relative viewpoint. In another example, “medial” refers to the direction towards the midline of a body or structure, and “lateral” refers to the direction away from the midline of a body or structure. In some examples, “lateral” or “laterally” may refer to any sideways direction. In another example, “superior” refers to the top of a body or structure, while “inferior” refers to the bottom of a body or structure. It should be understood, however, that the directional term of reference may be interpreted within the context of a specific body or structure, such that a directional term referring to a location in the context of the reference body or structure may remain consistent as the orientation of the body or structure changes.

Described herein are methods, apparatuses, and systems for flattening a specimen. Although methods, apparatuses, and systems for flattening a specimen are disclosed, it should be appreciated that aspects of the devices, systems, and methods disclosed herein may be operated in conjunction with other systems, devices, or methods including any surgical technique, any specimen retrieval method, any specimen preparation method, any specimen preservation method, any method to enhance imaging of a specimen, any immunohistochemistry method, any histology method, any imaging method, any microscope or microscopy method, any image analysis method, and any disease or condition diagnosis method.

In some aspects, the invention relates to an apparatus for flattening a specimen. The flattened specimen may then be imaged using optical coherence tomography, imaged using any microscopy technique including fluorescence microscopy, or sectioned into histology slides. In some embodiments, the apparatus includes a vacuum chamber in which a specimen to be flattened is positioned. The vacuum chamber may include a flexible membrane and a flat compression surface. The flexible membrane may be on a surface of the vacuum chamber and positioned opposite the flat compression surface. The specimen may be oriented in the vacuum chamber such that the specimen surface to be flattened is in contact with the flat compression surface. The specimen may be positioned such that it is in between the flexible membrane and the flat compression surface. The vacuum chamber may be sealed airtight and may be attached to a vacuum pump that may be used to depressurize the vacuum chamber. The vacuum pump may also remove excess fluid, including gas and liquid, from the vacuum chamber. The depressurization of the vacuum chamber may result in a lower pressure in the vacuum chamber than in the external environment of the vacuum chamber. The decrease in pressure in the vacuum chamber relative to the external environment, for example the atmosphere, may cause a force to be exerted on the flexible membrane which in turn exerts a force on the specimen compressing the specimen against the flat compression surface.

The flexible membrane may be highly flexible and may adhere to the shape of the specimen as it transmits a force to the specimen, producing a uniform pressure on the specimen and compressing the specimen against the flat compression surface. The specimen may be substantially flattened against the flat compression surface. After a desired amount of flattening has occurred, the vacuum pump may be disengaged, and the vacuum chamber may remain sealed airtight such that the specimen remains flattened. The flexible membrane may be amenable to manipulation by the operator of the apparatus such that folds, bubbles, or any other undesirable specimen shapes may be corrected through manipulation of the specimen through the flexible membrane. The flat compression surface may be optically transparent or otherwise amenable to imaging such that the flattened specimen may be imaged through the flat compression surface. The flattened specimen may be preserved in the flattened state by fixation or freezing for downstream applications including histological sectioning or immunohistochemistry. The vacuum chamber may be cooled to freeze the specimen or any fixing solution may be inserted into the chamber to preserve the specimen. The vacuum chamber may have a lid or other removable opening such that a specimen can be retrieved after the specimen is flattened.

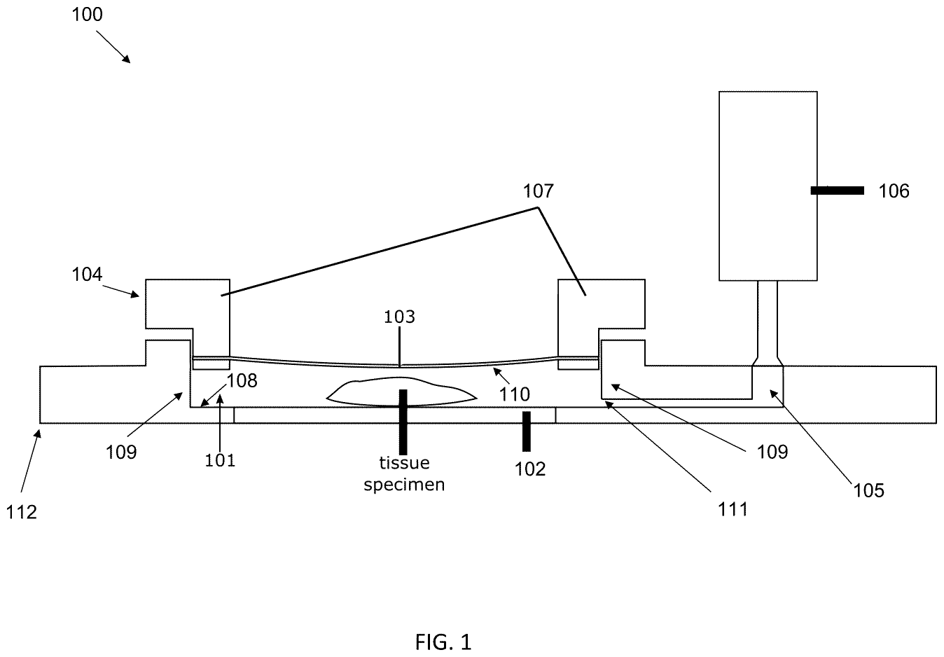

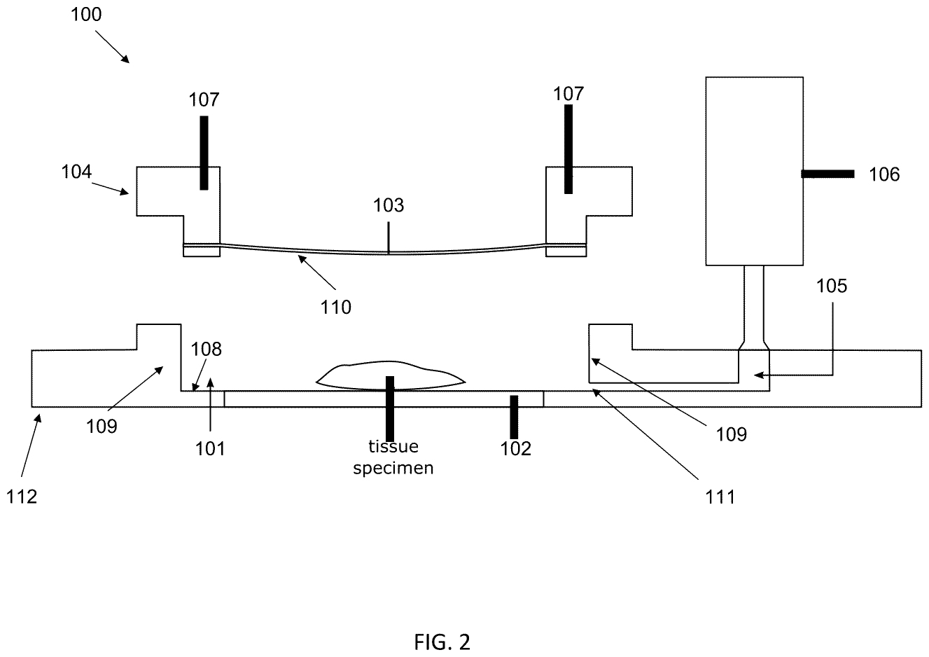

Now referring to FIG. 1 and FIG. 2, in some aspects, the invention relates to an apparatus 100 for flattening a specimen. In some embodiments, the apparatus 100 includes a primary vacuum chamber 101. A specimen, for example a tissue specimen, may be positioned in the primary vacuum chamber 101 in between a flat compression surface 102 and a flexible membrane 103. For example, a specimen may be placed onto a flat compression surface 102 such that the specimen is resting on the flat compression surface 102. The flat compression surface 102 may be below the specimen and the flexible membrane 103 may be above the specimen. The specimen may be positioned such that it is resting against the flat compression surface 102 and such that there is a spacing in the primary vacuum chamber 101 between the specimen and the flexible membrane 103 above. The specimen may be positioned such that it is resting against the flat compression surface 102 and such that there is contact between the specimen and the flexible membrane 103 above.

The primary vacuum chamber 101 may be any shape. For example, the primary vacuum chamber 101 may be a rectangular prism or a cube. The apparatus 100 may incorporate a means of accessing the primary vacuum chamber 101 such that a specimen can be loaded or removed from the primary vacuum chamber 101. For example, the primary vacuum chamber 101 may have any sealable opening. The sealable opening may have a corresponding covering. The corresponding covering may be removed from the sealable opening such that a specimen can be positioned in the vacuum chamber 101. The corresponding covering may then be applied to the sealable opening such that there is an airtight seal and such that the primary vacuum chamber 101 is airtight. In some embodiments, the primary vacuum chamber 101 is bounded by a bottom surface 108, any number of side walls 109, and a top surface 110. In some embodiments, the bottom surface 108 includes a flat compression surface 102. In some embodiments, the top surface 110 includes a flexible membrane 103. In some embodiments, the flat compression surface 102 is across from the flexible membrane 103 with the primary vacuum chamber 101 in between.

In some embodiments, the primary vacuum chamber 101 is bounded by a bottom surface 108 and a top surface 110. For example, the top surface 110 may include a flexible membrane 103 and a perimeter. The perimeter may comprise a solid structure. The perimeter may comprise a retainer. In this embodiment, a specimen may be positioned on the flat compression surface 102 prior to placing the top surface 110 over the specimen. In this example, the flexible membrane 103 may deform as it is placed over the specimen, thereby forming a primary vacuum chamber 101 being bounded by the perimeter, the flexible membrane 103 and the bottom surface 108.

In some embodiments, the primary vacuum chamber 101 includes a primary lid 104. In this embodiment, the primary lid 104 may be applied to a sealable opening of the primary vacuum chamber 101 to generate an airtight seal. For example, as in FIG. 1, the primary vacuum chamber 101 may have a top opening that may be sealed by a primary lid 104. The primary lid 104 may be removable and may reveal a primary vacuum chamber 101 opening, for example a top opening, when removed as in FIG. 2. The primary lid 104, when applied, may be the top surface 110 or part of the top surface 110 of a primary vacuum chamber 101. In some embodiments, the primary lid 104 includes the flexible membrane 103 such that the flexible membrane 103 forms part of a top surface 110 of a primary vacuum chamber 101. In some embodiments, the primary lid 104 includes a retainer 107. The retainer 107 may be attached to the flexible membrane 103. The primary lid 104 may be designed such that the retainer 107 makes up the edges, or exterior of the face of the primary lid 104 and the flexible membrane 103 makes up the interior of the face of the primary lid 104. In other words, the retainer 107 may make up the edges of the top surface 110 that bounds the primary vacuum chamber 101, and the flexible membrane 103 may make up the interior of the top surface 110 that bounds the primary vacuum chamber 101. The retainer 107 may be designed such that it can be placed against and/or on top of a side wall 109 or side walls 109 of a primary vacuum chamber 101. The retainer 107 may be designed such that it can be placed directly against bottom surface 108 and/or flat compression surface 102. For example, in some embodiments, the apparatus may not comprise side walls 109, and the primary lid 104 may only comprise a flexible membrane 103 and a retainer 107 configured to be placed directly against the bottom surface 108 and/or flat compression surface 102. In some embodiments, the retainer 107 is designed such that the top surface 110 including the flexible membrane 103 can be rapidly removed by an operator of the apparatus for access to the primary vacuum chamber 101 and/or the specimen.

In some embodiments, a vacuum pump 106 is fluidly connected to the primary vacuum chamber 101. The vacuum pump 106 may be connected to the primary vacuum chamber 101 through a vacuum port 105. In some embodiments, the vacuum port 105 is directly connected to the primary vacuum chamber 101. In some embodiments, the vacuum port 105 connects the vacuum pump 106 to the primary vacuum chamber 101 through a vacuum conduit 111. The vacuum port 105 may be located at any boundary of the primary vacuum chamber 101. For example, the vacuum port 105 may be located on the top surface 110, the bottom surface 108, or on any side wall 109 such that the vacuum port 105 enables air to be evacuated from the primary vacuum chamber 101.

In some embodiments, the apparatus includes a base 112. The base 112 may include the bottom surface 108 and side walls 109 of the primary vacuum chamber 101. The base 112 may further include a vacuum port 105 and a vacuum conduit 111 that connects the primary vacuum chamber 101 to the vacuum pump 106. In some embodiments, the edges of the opening of the vacuum conduit 111 to the primary vacuum chamber 101 includes portions of a side wall 109 and the bottom surface 108. In some embodiments, the opening that connects the primary vacuum chamber 101 to the vacuum pump 106 is positioned in the bottom surface 108 or in between the bottom surface 108 and a side wall 109 such that excess fluid, including gases and liquids, in the primary vacuum chamber 101 can more easily be removed by the vacuum pump 106. For example, excess liquid may settle at the bottom surface 108 and may be more easily removed by the action of the vacuum pump 106 through an opening near or at the bottom surface 108. In some embodiments, the opening of the vacuum conduit 111 to the primary vacuum chamber is located adjacent to the flat compression surface 102 of the bottom surface 108. The opening of the vacuum conduit 111 or vacuum port 105 to the primary vacuum chamber 101 may be any shape, for example a square, a rectangle, an ellipse, or a circle. In some embodiments, the opening is a rectangle that spans the whole length of a side wall 109 and is any height. The opening may be adjacent to the bottom surface 108 and may span the whole length of a side wall 109 such that any excess fluid on the bottom surface 108 is more easily removed through the opening. In some embodiments, multiple vacuum pumps 106 may be connected to the primary vacuum chamber. In some embodiments, multiple vacuum ports 105 or vacuum conduits 111 are connected to the primary vacuum chamber 101.

In some embodiments, a valve may be included in a vacuum line in between a vacuum pump 106 and a vacuum port 105. It may be advantageous for the vacuum pump 106 to disconnect from the apparatus 100 for ergonomic or portability purposes. For example, after a specimen is flattened, the apparatus 100 may then be carried or otherwise transported to be examined by any person or with any additional equipment. In this embodiment, a valve may be closed such that the primary vacuum chamber 101 may remain depressurized after a vacuum pump 106 is removed.

In some embodiments, the primary lid 104 includes a flat compression surface in place of the flexible membrane 103. In some embodiments, the primary lid 104 is entirely composed of a flat compression surface. In these embodiments, the base includes a flexible membrane in place of the flat compression surface. In some embodiments, a flexible membrane and a flat compression surface are included in any boundary of the primary vacuum chamber 101 after it is constructed such that the flexible membrane is across from the flat compression surface with the vacuum chamber in between.

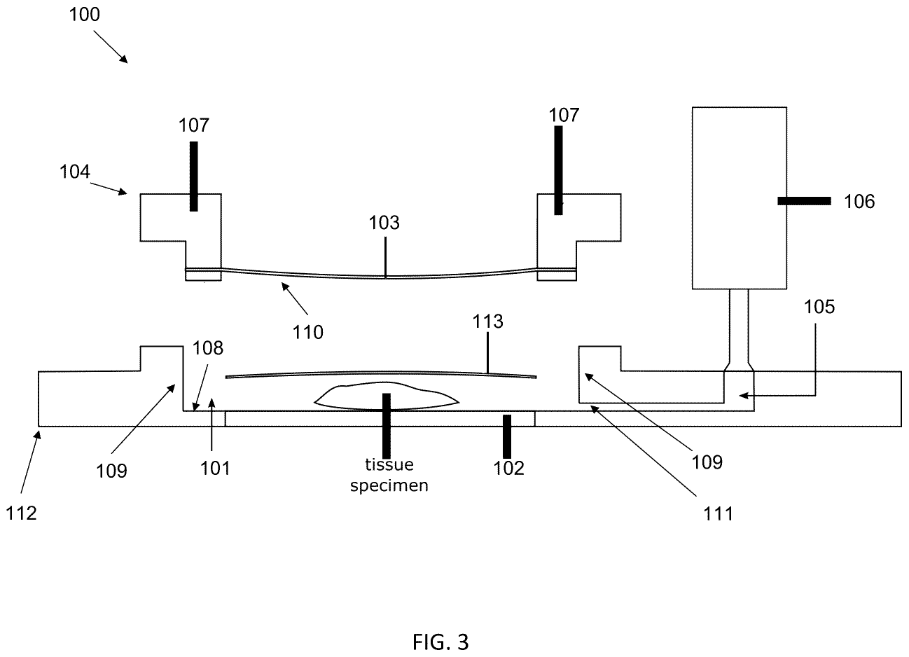

Now referring to FIG. 3, in some embodiments, the apparatus 100 includes a fluid wicking liner 113. The fluid wicking liner may be designed or positioned such that gas and fluid may be more efficiently extracted from the primary vacuum chamber 101. As a specimen is compressed, fluid may be released from the specimen and may be extracted by absorption or wicking through the fluid wicking liner 113. For example, the fluid wicking liner 113 may aid in facilitating the extraction of additional fluid, including gas and liquid, released after the flexible membrane 103 exerts force on the positioned specimen. The fluid wicking liner 113 may be positioned at any location in the primary vacuum chamber 101. For example, the fluid wicking liner 113 may be positioned between the flexible membrane 103 and the specimen surface. The fluid wicking liner may be any dimensions. The fluid wicking liner 113 may be a thin material. For example, the fluid wicking liner 113 may be substantially thin and may have surface dimensions such that it fits against the primary lid 104 when the primary lid 104 is applied. The fluid wicking liner 113 may be positioned on top of a tissue specimen in the primary vacuum chamber 101 such that it is contacting the tissue specimen. The fluid wicking liner 113 may be any material that absorbs fluids, wicks fluid, or directs fluid in any direction, for example any fibrous material, any hydrophilic material, any amphipathic material, any porous material, cellulose, paper, synthetic wick, plastic wick, cotton, any water permeable material, or any combinations thereof. In some embodiments, multiple fluid wicking liners 113 may be positioned in the primary vacuum chamber 101.

The fluid wicking liner 113 may extend outward past the specimen to prevent direct contact between the flexible membrane 103 and the flat compression surface 102. Direct contact between the flexible membrane 103 and the flat compression surface 102 may be undesirable and may prevent excess gas or liquid from being evacuated from the primary vacuum chamber. For example, direct contact may physically block the access of a vacuum pump to excess gas and liquids through the opening to the vacuum conduit 111 or the vacuum port 105. Physical blockages may promote the formation of undesirable gas or liquid bubbles in the primary vacuum chamber 101 near the specimen. Direct contact between the flexible membrane 103 and flat compression surface 102 may trap fluid when using certain methods of operating the apparatus in which compression of the specimen and fluid evacuation from the primary vacuum chamber 101 occur concurrently. The use of a fluid wicking liner 113 positioned in the primary vacuum chamber 101 may be particularly useful in this case.

The primary vacuum chamber 101 may be any dimensions. In some embodiments, the dimensions of the primary vacuum chamber 101 are designed to fit a desired specimen. For example, the primary vacuum chamber 101 may be of a height that is greater than the height of a tissue specimen such that there is a spacing between the flexible membrane 103 and the tissue specimen before any compressive force is applied to the flexible membrane 103. In some embodiments, the spacing between the flexible membrane 103 and the tissue specimen is large enough to fit a fluid wicking liner 113. In some embodiments, the primary vacuum chamber 101 is of a height that is about the height of a tissue specimen such that there may be some contact between the flexible membrane 103 and the tissue specimen before any compressive force is applied to the flexible membrane 103. In some embodiments, the primary vacuum chamber bottom surface 108 has a larger surface area than an uncompressed specimen to such that the specimen may spread out on the bottom surface 108 after flattening.

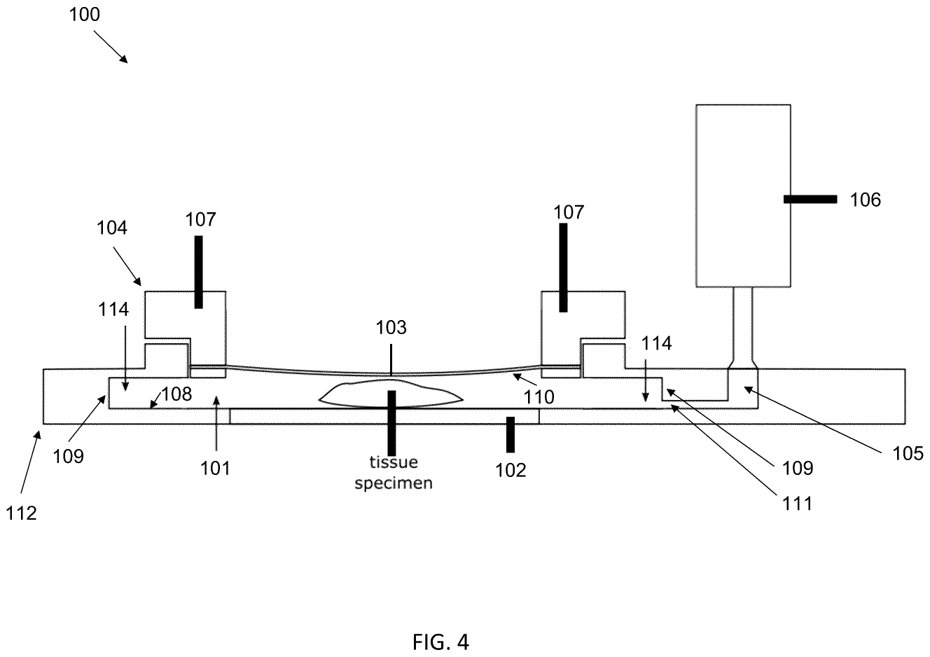

Now referring to FIG. 4, the primary vacuum chamber 101 may include one or more expansion spaces 114. Expansion spaces 114 may extend laterally such that the bottom surface 108 has a greater surface area than the primary lid 104 or a greater surface area than the flexible membrane 103. Expansion spaces 114 may be designed to allow more room on the bottom surface for a specimen to flatten and spread out. Expansion spaces 114 may allow further radial stretching of the flexible membrane 103 in response to pressure differences across the flexible membrane 103. Further radial stretching of the flexible membrane 103 may cause shearing of the top of the positioned specimen. Radial stretching of the flexible membrane 103 and shearing of the top of the positioned specimen may reduce folds in the specimen during or after flattening. In some embodiments, the flexible membrane 103 expands radially outward along the flat compression surface 102 as the primary vacuum chamber 101 is depressurized. In some embodiments, the flexible membrane 103 is supported a short distance above the flat compression surface 102 while the bottom surface 108 of the primary vacuum chamber extends a significant distance laterally beyond the flat compression surface 102. For example, as the flexible membrane 103 stretches under the force of a pressure differential, the flexible membrane 103 will first contact the specimen surface and then the flexible membrane 103 will be stretched perpendicular to the specimen as the specimen expands into the expansion spaces 114. This type of motion may roll the surface of the specimen outward and reduce folds in the specimen.

The flat compression surface 102 may be any surface that is substantially flat. The flat compression surface 102 material may be designed, chosen, or engineered such that it can remain flat or otherwise maintain its structure or shape in the presence of a pressure difference generated by depressurization of the primary vacuum chamber 101. The flat compression surface 102 may support a positioned specimen. The flat compression surface 102 may be optically transparent or partially optically transparent to enable visualization of the tissue as it is flattened. The flat compression surface 102 may be optically transparent or partially optically transparent such that a specimen may be imaged through the flat compression surface 102. For example, the use of an optically transparent or partially optically transparent flat compression surface 102 may allow for the visual inspection of the specimen through the flat compression surface 102.

For example, the flat compression surface 102 may be of a material that is compatible with optical coherence tomography, fluorescence microscopy, white light cameras, or any other imaging modality or imaging device. In some embodiments, the flat compression surface 102 is transparent to only a subset of light wavelengths. In some embodiments, the flat compression surface 102 is of a thickness that is less than the working distance of a microscope objective that is desired for acquiring microscopy images. The flat compression surface 102 may function as a coverslip. The flat compression surface 102 may be a portion of the bottom surface 108 or may be the entirety of the bottom surface 108.

In a preferred embodiment, the flat compression surface 102 remains substantially flat under compression, the mechanism of flattening is the force applied by the atmosphere onto the flexible membrane 103. It will be evident that this force is exactly equal and opposite to the force of the atmosphere on the external surface of the flat compression surface 102. Therefore, the flat compression surface 102 experiences no net force and is not deflected into a non-flat shape by the force of the atmosphere. As no net force is experienced by the flat compression surface 102, this surface can potentially be made of optically thin, delicate, or otherwise not structurally rigid materials such as microscope cover slips or cover glass in order to facilitate imaging through the flat compression surface 102. For example, in some embodiments, the flat compression surface 102 could be composed of optical glass or cover glass between 0.05 mm and 2.0 mm in thickness.

In contrast, positive pressure flattening devices, such as devices that incorporate balloons to apply a net positive force to a surface, may deform the surface into a non-flat shape therefore not allowing the use of materials that are thin, delicate, or otherwise not structurally rigid such as microscope cover slips or cover glass.

Typical biopsy specimens have dimensions on the order of 1 to 10 mm, and typical surgical pathology specimens have dimensions on the order of 1 to 100 mm. Thus, the preferred embodiment of the primary vacuum chamber designed for biopsy specimens fits the largest expected biopsy specimen dimensions with a margin of space for the specimen to flatten into. Thus, the preferred embodiment of the primary vacuum chamber dimensions are on the order of 5-50 mm. Similarly, in the preferred embodiment of the vacuum chamber sized for surgical pathology specimens, the dimensions of the primary vacuum are between 5-200 mm on each side.

The dimensions of the flat compression surface 102 should be chosen to accommodate the largest possible specimens in the application with some additional space on either side in order for the flattened specimen to extend into without hitting the edges. The size will thus depend on the application, with for example biopsies requiring smaller compression surfaces on the order of 0.5 cm to 5 cm by 0.5 to 5 cm. Conversely larger surgical pathology specimens may require 1 cm to 10 cm by 1 cm to 10 cm. The largest specimens, which might include whole surgical excisions could require surfaces up to 30 cm in width. Additionally, in some applications it may be advantageous to flatten multiple specimens simultaneously, for example in surgeries that produce multiple excisions or when processing multiple biopsies. In this case, the area of the flat compression surface 102 should be multiplied by the number of expected specimens such that each can fit without overlapping. In the preferred embodiment, the flat compression surface 102 is large enough to accommodate a variety of biopsy and pathology specimens, typically 5-10 cm on both sides.

In some embodiments, a camera, a microscope, and/or illumination or light source are positioned to image, observe, examine, or illuminate the specimen through the flat compression surface 102. In some embodiments, a camera, a microscope, and/or illumination or light source is incorporated within the apparatus 100. In some embodiments, a camera, a microscope, and/or illumination or light source are configured to detect folds in a specimen to assess specimen flatness. In some embodiments, a camera, a microscope, and/or illumination or light source are configured to examine the specimen to assess any specimen characteristic. In some embodiments, the apparatus 100 may be fitted onto a microscope stage such that the flat compression surface 102 faces an objective of the microscope. In some embodiments, the entire apparatus 100 may be inverted such that specimen adherence to the flat compression surface 102 may be inspected or any other characteristic of the specimen can be examined. In some embodiments, total internal reflection or high angle illumination may be utilized to determine where the specimen is physically contacting the flat compression surface 102. In some embodiments, total internal reflection or high angle illumination are used when the flat compression surface 102 is glass.

The flat compression surface 102 may be any glass, any plastic, any metal, a crystal, calcium fluoride glass, magnesium fluoride glass, borosilicate glass, any other material or any combination of materials. The flat compression surface 102 may be a high thermal conductivity material such that the flat compression surface 102 may be cooled rapidly. High thermal conductivity materials may include metal, and/or thermally conductive glass or crystal, for example calcium or magnesium fluoride glass. The cooling of a flat compression surface 102 may allow for the freezing of a flattened specimen. Therefore the specimen can be preserved frozen in a flattened state that is suitable for cryosectioning techniques. For example, the flattened tissue could be directly frozen onto the flat compression surface, locking it into a flat shape before embedding and sectioning. The flat compression surface 102 may be an optically flat surface that facilitates imaging.

The flexible membrane 103 may function to prevent air leakage and maintain an airtight seal in the primary vacuum chamber 101. The flexible membrane 103 may also function to transmit the force generated by a pressure differential between the primary vacuum chamber 101 and the external environment to the specimen. There may be less pressure in the primary vacuum chamber 101 than the external environment such that the flexible membrane 103 transmits a force to the specimen and flattens the specimen against the flat compression surface 102. The flexible membrane 103 may be sufficiently thin and sufficiently flexible such that force is transmitted to the specimen efficiently and a minimal amount of excess gas and liquid remains trapped around the specimen.

The flexible membrane 103 may be any flexible material. For example, any plastic, rubber, silicone, or latex may be used. The flexible membrane 103 may be rigid enough so that it remains flat in the absence of a pressure difference generated between the primary vacuum chamber 101 and the atmosphere or other exterior environment. The flexible membrane 103 may be flexible enough so that pressure differences generated between the primary vacuum chamber 101 and the atmosphere or other exterior environment causes the flexible membrane 103 to change shape such that a compressive force is exerted on a specimen inside the primary vacuum chamber 101. In some embodiments, the flexible membrane may be optically transparent or partially optically transparent such that the specimen can be visualized through the flexible membrane. In some embodiments, the flexible membrane 103 is pliable such that the specimen can be manipulated by an operator through manipulation of the flexible membrane 103. For example, folds in flattened specimen may be removed by an operator by rolling out, kneading, or otherwise applying pressure at different locations of the flexible membrane 103. In some embodiments, there may be wide, easily accessed space around the flexible membrane 103 such that a user may quickly reach in and manipulate a specimen.

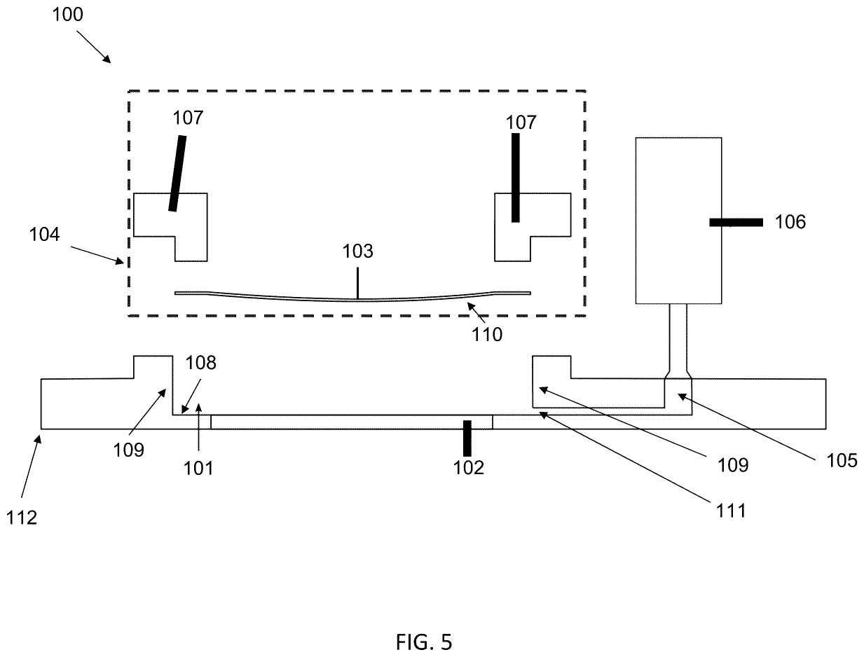

Now referring to FIG. 5, in some embodiments, the flexible membrane 103 and the retainer 107 of the primary lid 104 are not attached. In this embodiment, the flexible membrane 103 and the retainer 107 may be separate pieces. In some embodiments, the flexible membrane 103 may be applied to the top opening of the primary vacuum chamber 101. The retainer 107 may be applied on top of the flexible membrane 103, and the retainer 107 may be designed such that it functions to maintain the flexible membrane 103 in place at the top surface 110 of the primary vacuum chamber 101. For example, the retainer 107 may be weighted such that it can maintain the flexible membrane 103 in place atop the primary vacuum chamber 101. In some embodiments, the flexible membrane 103 and the retainer 107 are assembled to form the primary lid 104. In some embodiments, the flexible membrane 103 and the retainer 107 may be released from the apparatus 100 separately.

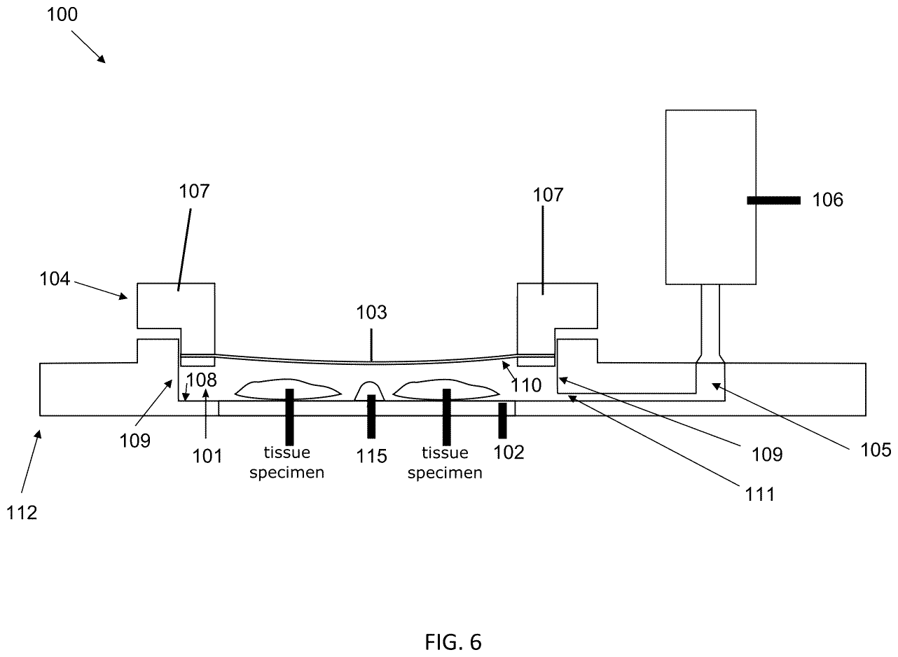

Now referring to FIG. 6, in some embodiments, the apparatus 100 may be used to flatten multiple specimens concurrently. For example, regions of the flat compression surface 102 may be subdivided such that two or more distinct specimens can be positioned in each subdivided region. For example, the flat compression surface 102 may have a surface area large enough to fit any number of specimens. In some embodiments, the apparatus 100 includes a divider 115. A divider 115 may extend upward from the flat compression surface 102 and may function to prevent multiple specimens from contacting each other as they are flattened. In some embodiments, the divider 115 is a grid of any dimensions that extends upward from the flat compression surface 102 forming any number of locations in which a specimen can be placed. In some embodiments, the flat compression surface 102 is subdivided into any number of independent surfaces. Each independent surface may be positioned under a common flexible membrane 103. In some embodiments, the flexible membrane 103 may be subdivided to correspond with any number of independent surface sections of the flat compression surface 102. In some embodiments, a rigid material may be positioned in between multiple sections of the flexible membrane 103 such that each section corresponds with a surface section of the flat compression surface 102. In this embodiment, each section may be in the same primary vacuum chamber 101.

The primary lid 104 may be any dimensions. The primary lid 104 may be designed such that it generates an airtight seal against the side walls 109 of the primary vacuum chamber. The primary lid 104 may be designed such that it generates an airtight seal against any portion of the base 112 such that the primary lid 104 encloses at least some of the bottom surface 108 of the base 112 to form a primary vacuum chamber 101. In some embodiments, a portion of the primary lid 104 makes up the side walls 109 or a portion of the side walls 109 of the primary vacuum chamber 101. In some embodiments, the retainer 107 of the primary lid 104 makes up the side walls 109 or a portion of the side walls 109 of the primary vacuum chamber 101.

In some embodiments, the primary lid 104 is secured in place after it is applied to the top opening of the primary vacuum chamber 101. For example, the primary lid 104 or a portion of the primary lid 104 including the retainer 107 may be weighted such that the primary lid 104 remains in place after it is applied. In some embodiments, the primary lid 104 including the retainer 107 may include a plurality of recesses that fits against a plurality of extrusions of the base 112. In some embodiments, the primary lid 104 or a portion of the primary lid 104 including the retainer 107 may be screwed or clamped against the base 112. In some embodiments, the primary lid 104 is placed over an opening of the primary vacuum chamber 101 and is secured by the pressure difference between the primary vacuum chamber 101 and the external environment.

In some embodiments, the apparatus 100 is placed inside of an external secondary vacuum chamber. The entire apparatus may fit inside of a large external secondary vacuum chamber. The larger external vacuum chamber and the primary vacuum chamber 101 may be concurrently depressurized. Since both chambers may be depressurized at the same time no compressive force may be applied onto the specimen by the flexible membrane 103. The larger vacuum chamber may then be equilibrated with atmospheric pressure or otherwise repressurized while the primary vacuum chamber 101 remains depressurized such that a pressure difference is generated across the flexible membrane 103. The flexible membrane 103 may then exert a force onto the specimen and compress the specimen against the flat compression surface 102. Depressurizing the primary vacuum chamber 101 and removing all excess fluid from the primary vacuum chamber 101 before any specimen flattening occurs may allow for more complete flattening or reduce the presence of bubbles and folds in the specimen.

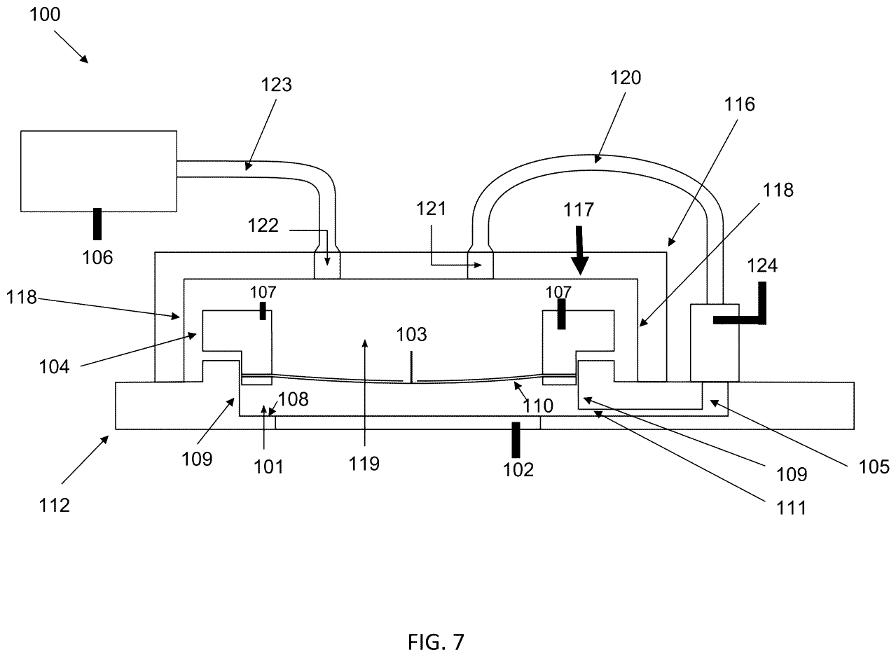

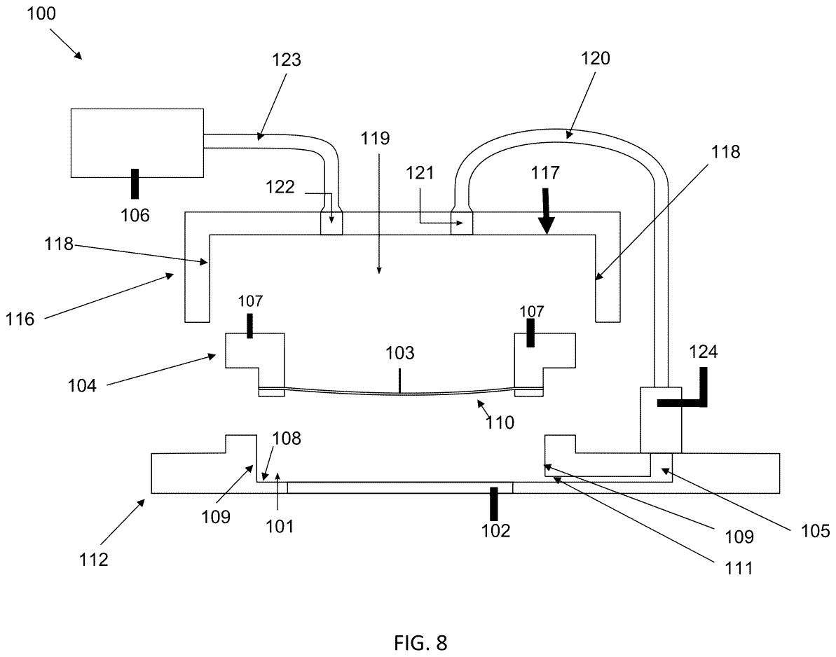

Now referring to FIG. 7 through FIG. 9, in some embodiments, the apparatus 100 includes two vacuum chambers. In some embodiments, the two vacuum chambers are primary vacuum chamber 101 and secondary vacuum chamber 119. In some embodiments, the flexible membrane 103 subdivides a primary vacuum chamber 101 and a secondary vacuum chamber 119. The flexible membrane 103 may serve as a divider or barrier between both vacuum chambers. In some embodiments, both vacuum chambers are fluidly connected through a connecting port valve. Initially, the connecting port valve may be open and both chambers may be concurrently depressurized by the vacuum pump 106. As both chambers are depressurized concurrently, there is no pressure difference across the flexible membrane 103 during depressurization. Additionally, the flexible membrane 103 does not exert a force on the positioned specimen or adhere to the positioned specimen during depressurization in this case. Any amount of fluid, including gases and liquids, may be extracted from the tissue during depressurization of the vacuum chambers. Any desired internal pressure may be achieved during depressurization.

After depressurization is concluded, the connecting port valve between the chambers may be closed and the secondary vacuum chamber 119 may be repressurized. The secondary vacuum chamber 119 may then be disconnected from the primary vacuum chamber 101. Repressurizing the secondary vacuum chamber 119 may cause the flexible membrane 103 to adhere to the positioned specimen and exert a force on the positioned specimen. Repressurization may be achieved by removing the secondary vacuum chamber 119 from the primary vacuum chamber 101 therefore exposing the exterior surface of the flexible membrane 103 to atmospheric pressure. Exposure of the tightly sealed depressurized primary vacuum chamber 101 to external atmospheric pressure may cause the flexible membrane 103 to adhere to the positioned specimen and exert a force on the positioned specimen.

In embodiments of a method in which fluids, including liquids and gases, are evacuated from the primary vacuum chamber 101 before any compression or flattening of the specimen and before any force is exerted on the specimen from the flexible membrane 103 may lead to a more complete adherence of the flexible membrane 103 to the positioned specimen. More complete adherence may be desirable for more complete flattening and for decreasing folds or bubbles. Removal of the secondary vacuum chamber 119 may expose the flexible membrane 103 to an operator such that a specimen can be manipulated through the flexible membrane 103 to correct any undesirable specimen shapes including folds.

In some embodiments, the apparatus 100 includes a secondary lid 116. The secondary lid 116 may be applied to the apparatus over the applied primary lid 104. The secondary lid 116 may contain a cavity with a bottom opening. The cavity may be bounded by a top surface 117 and side walls 118 that extend downward from the top surface 117. The side walls 118 of the secondary lid 116 may form an air tight seal with the base 112, primary lid 104, or primary lid 104 retainer 107 to form a secondary vacuum chamber 119. The secondary vacuum chamber 119 bottom surface may at least partially be comprised of the primary lid 104 and/or the flexible membrane 103 of the primary lid 104. The secondary vacuum chamber 119 and primary vacuum chamber 101 may be fluidly connected through a connecting port valve 124.

After the secondary lid 116 is applied to form the secondary vacuum chamber 119 such that the flexible membrane 103 subdivides primary vacuum chamber 101 and the secondary vacuum chamber 119, both chambers may be depressurized. In some embodiments, after depressurization, the secondary vacuum chamber 119 may be equilibrated with atmospheric pressure abruptly by removal of the secondary lid 116 or by the release of a valve. The connecting port valve 124 may be closed before the secondary vacuum chamber 119 is equilibrated with atmospheric pressure such that the primary vacuum chamber 101 remains depressurized. In some embodiments, after fluid has been evacuated from both chambers, air may be reintroduced to the secondary vacuum chamber 119 slowly, for example by the partial release of a valve or the use of an air pump, such that a pressure difference is generated gradually across the flexible membrane 103. This process of depressurizing the primary vacuum chamber 101 and/or evacuating fluid from the primary vacuum chamber 101 before compression of the specimen occurs may be desirable for preventing bubble formation of liquids or gases near the specimen during compression.

The primary vacuum chamber 101 may be fluidly connected to the secondary vacuum chamber 116 through conduits or ports. The conduits or ports may include valves such that the fluid connection between the vacuum chambers can be allowed or disrupted by an operator. In some examples, an embodiment of the apparatus 100 that includes only a single vacuum chamber, the primary vacuum chamber 101, can be converted to an embodiment of the apparatus 100 that includes a primary vacuum chamber 101 and a secondary vacuum chamber 119 by applying a secondary lid 116 over the top of the applied primary lid 104. Likewise, an embodiment of the apparatus 100 that includes a primary vacuum chamber 101 and a secondary vacuum chamber 119 may be converted to an embodiment of the apparatus 100 that includes only a primary vacuum chamber 101 by removing the secondary lid 116. The vacuum port 105 can then be fluidly connected to the secondary vacuum chamber 119 through a second vacuum conduit 120 and a second vacuum port 121. The vacuum pump 106 may be connected fluidly to the secondary vacuum chamber 119 which may in turn be fluidly connected to the primary vacuum chamber 101. The vacuum pump 106 may be fluidly connected to the secondary vacuum chamber 119 through a third vacuum port 122 and/or a third vacuum conduit 123. The vacuum pump 106 may optionally be fluidly connected to both vacuum chambers directly or only directly fluidly connected to the secondary vacuum chamber 119. In some embodiments, a valve 124 is positioned between the vacuum port 105 and the second vacuum port 121 such that the fluid connection between the primary vacuum chamber 101 and the secondary vacuum chamber 119 can be toggled.

The secondary lid 116 and primary lid 104 may both be removable. The secondary lid 116 and primary lid 104 may be connected to the appropriate vacuum ports and conduits before or after they are applied. In some embodiments, it may be desirable for packaging and portability for the vacuum pump 106, and any vacuum conduits or valves to be detachable. In some embodiments, the applied secondary lid 116 forms an airtight seal with primary lid 104, primary lid retainer 107, or the base 112. In some embodiments, the secondary lid 116 may be secured after it is applied by any mechanism, for example any mechanism described to secure the primary lid 104. In some embodiments, the secondary lid 116 is secured by screws including thumb screws, clamps, or by a generated pressure differential between the atmosphere and the secondary vacuum chamber 119.

In some embodiments, air-tight seals can be formed using an o-ring or any similar compressible seal. The compressible seal may be designed, engineered, or chosen such that any lids including the primary lid 104 and secondary lid 116 can form a tight seal against the base 112 or any other portion of the apparatus 100 using thumb screws or a generated pressure difference across any lid. A tight seal may also be generated or enhanced through the use of any bolts, any screws, any clamps, or any other compression or securing mechanism.

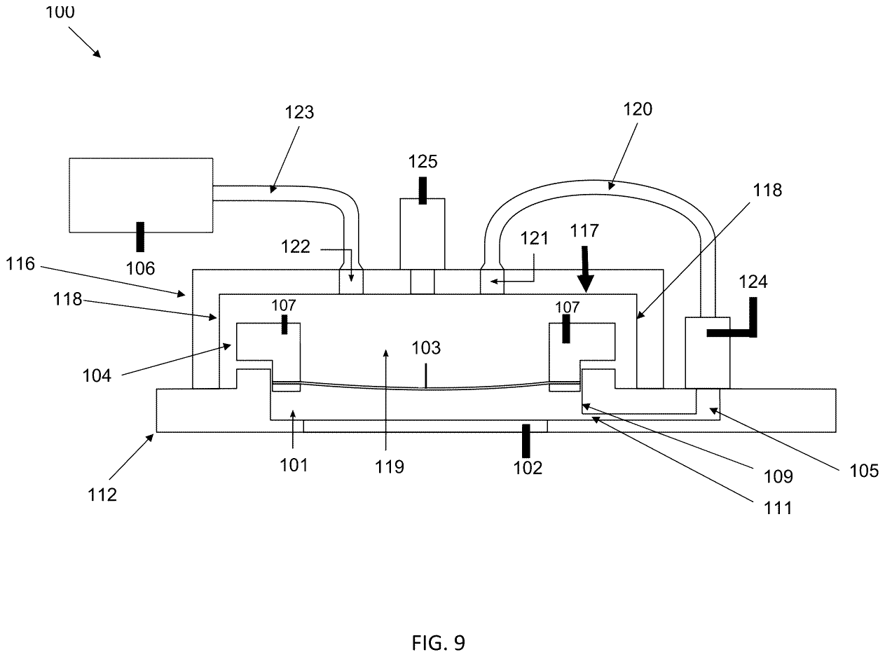

Now referring to FIG. 9, the secondary vacuum chamber 119 may be equilibrated with atmospheric pressure at any point. In some embodiments, the secondary vacuum chamber 119 is equilibrated with atmospheric pressure by the release of a valve, for example atmospheric valve 125. The release of the atmospheric valve 125 may allow for the abrupt equilibration of the secondary vacuum chamber 119 with atmospheric pressure. In some embodiments, the fluid connection between the two vacuum chambers, primary vacuum chamber 101 and secondary vacuum chamber 119, is disrupted by the closing of a valve, for example connecting valve 124, or any other mechanism before the secondary vacuum chamber 119 is equilibrated with atmospheric pressure. In this embodiment, pressure remains low in the primary vacuum chamber 101 after the secondary vacuum chamber 119 is equilibrated with atmospheric pressure. The atmospheric valve 125 may be positioned on any boundary of the secondary vacuum chamber 119, for example the top or any side.

An abrupt equilibration to atmospheric pressure in the secondary vacuum chamber 119 may result in a substantial amount of specimen compression in the primary vacuum chamber 101 over a short amount of time. In some embodiments, the atmospheric valve 125 may be opened only a small amount such that pressure in the secondary vacuum chamber 119 is equilibrated with atmospheric pressure more gradually. Gradual equilibration may be desirable to prevent sudden movement or force on apparatus 100 components. Equilibration of the secondary vacuum chamber 119 may allow for the removal of the secondary lid 116. The secondary lid 116 may be removed so that the flexible membrane 103 can be accessed by an operator of the apparatus 100 for manipulation and correction of any undesirable compression effects in the specimen including bubbles or folds.

In some embodiments, a vacuum pump 106 may be connected to the secondary vacuum chamber 119 with the atmospheric valve 125 between the vacuum pump 106 and a vacuum port to the secondary vacuum chamber 119. For example, a vacuum pump 106 may have its own mechanism to prevent backflow or the atmospheric valve 125 may be closed to prevent any air backflow from the vacuum chamber to the vacuum pump 106. In some embodiments, the atmospheric valve 125 may be omitted and instead the pressure in the secondary vacuum chamber 119 may be equilibrated by disconnecting the vacuum pump 106 from an open vacuum port or the vacuum pump 106 may be run in reverse to push air back into the vacuum chamber.

The secondary lid 116 may be removed after it is applied by any mechanism. After fluid in both chambers have been evacuated, the fluid connection between both chambers may be disrupted. The removal of the secondary lid 116 itself may generate a pressure differential across the flexible membrane 103, for example with the atmosphere on one side and the depressurized primary vacuum chamber 101 on the other side, to cause compression of a specimen. The secondary lid 116 may be removed by the removal of screws, removal of clamps, and/or the application of pulling or sliding force.

Any vacuum port or vacuum conduit of the apparatus 100 may be fitted with a valve that may be controlled by an operator. A valve may open a port such that pressure differences across the port may be equilibrated. A valve may close a port such that pressure differences across the port can be maintained. Valves may be opened or closed partially such that pressure differences across a port can be equilibrated gradually. Any valve may be used in the apparatus 100. For example, valves may be simple manual ball valves, automatic devices, automatic devices such as solenoids controlled by a computer, or automatic mechanical devices. In some embodiments, check valves may be used that function by restricting flow to only one direction. If solenoids are utilized for valves, a computer system may automatically actuate the vacuum pump 106 or any valves to evacuate fluid one or both chambers, maintain any specified pressure in one or both chambers, or repressurize one or both chambers. In some embodiments of the apparatus 100 with two vacuum chambers, a computer system may control a valve between the two chambers as well as an atmospheric valve of the secondary vacuum chamber 119. In some embodiments, the vacuum pump 106 and the closure or release of valves can be controlled automatically by computer such that fluid is evacuated from both chambers and then only the secondary vacuum chamber 119 is repressurized. This would result in a pressure difference across the flexible membrane 103 and the compression of a specimen against the flat compression surface 102.

Any vacuum conduits of the apparatus 100 may be any dimensions including any length, any cross-sectional shape, any diameter, or any other characteristic dimensions. The vacuum conduits may be airtight.

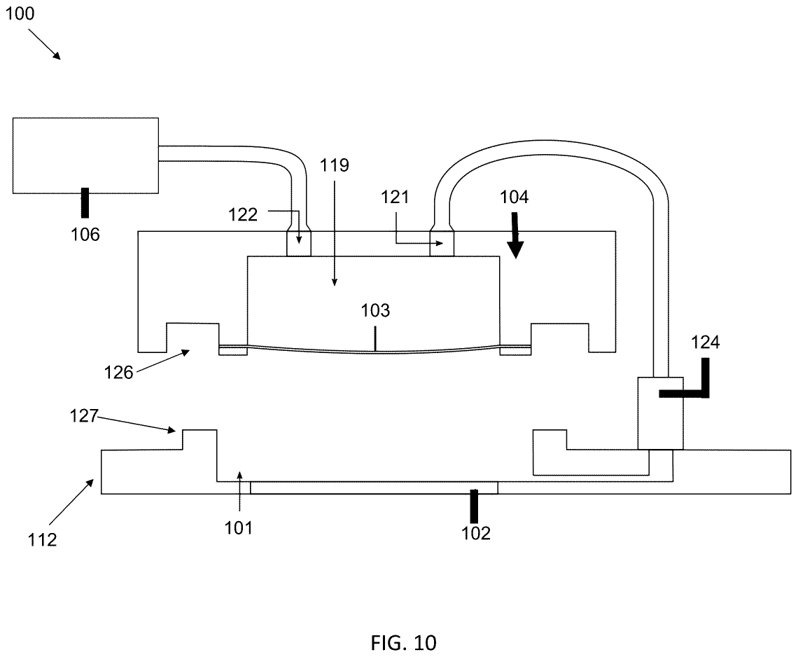

Now referring to FIG. 10, in some embodiments, the secondary vacuum chamber 119 may be included in the primary lid 104. In these embodiments, the apparatus 100 may not include a secondary lid 116. The primary lid 104 may include an airtight cavity that functions as the secondary vacuum chamber 119. The airtight cavity may be bounded by the flexible membrane 103 at the bottom surface, side walls, and a top surface. In these embodiments, the apparatus 100 may function or be configured similarly to any other double vacuum chamber embodiments. This embodiment may be desirable to reduce the number of component parts of the apparatus 100. In some embodiments, the top surface or side walls of the airtight cavity of the primary lid 104 are optically transparent or at least partially optically transparent such that the flexible membrane 103 and the top surface of the specimen may be visually inspected at any point during specimen flattening. In some embodiments, the primary lid 104 includes one or more recesses 126 that fit into an extrusion 127 of the base such that the primary lid 104 may remain in place after it is applied or such that an airtight seal may be better formed.

In some embodiments, any device that can evacuate gas and/or liquid from a vacuum chamber may serve as the vacuum pump 106. In some embodiments, a hand pump, or a syringe pump may be operated manually and may be used as the vacuum pump 106. For example, any tube or tubing may be used to connect a hand pump or syringe pump to a vacuum chamber. Hand pumps and syringe pumps may be a low cost vacuum pump option. Hand pumps and syringe pumps may be compact, easily storable, easily packable, and/or easily transported. Hand pumps and syringe pumps may be used when a very strong vacuum pump is not needed. In some embodiments, an electrically powered vacuum pump may be used. An electrically powered vacuum pump may enable more rapid and more complete gas and/or liquid evacuation from a vacuum chamber. An electrically powered vacuum pump may be desirable for larger vacuum chambers or for generating greater pressure differences. In some embodiments, an external vacuum line may be used as the vacuum pump 106 and may directly remove air from the system. In some embodiments, external positive pressure lines may be used to drive a pneumatic or venturi pump. In some embodiments, a reciprocating pump or a peristaltic pump is used as the vacuum pump 106.

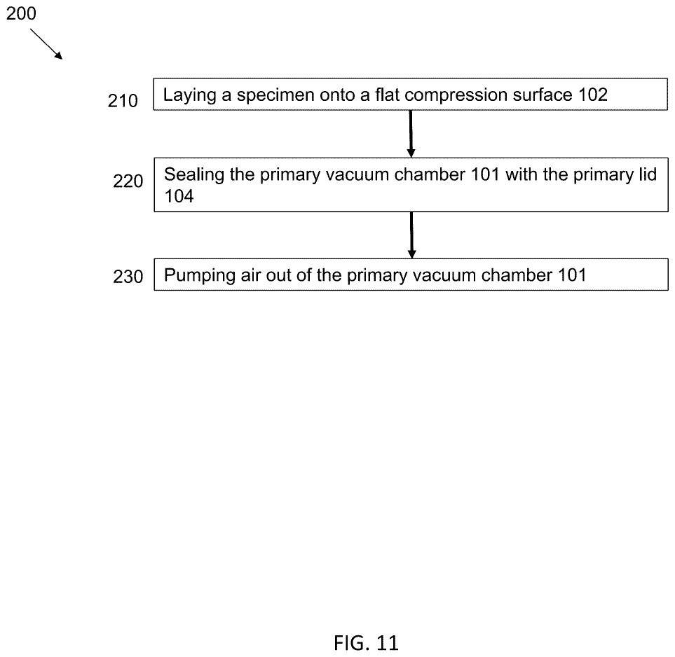

In some aspects, the invention relates to various methods. Reference is now made to FIG. 11. In some aspects, the invention relates to a method 200 of flattening a specimen using an embodiment of a specimen flattening apparatus 100 with one vacuum chamber. In some embodiments, the method includes 210 laying a specimen onto a flat compression surface 102; 220 sealing the primary vacuum chamber 101 with the primary lid 104; and 230 pumping out air of the primary vacuum chamber 101.

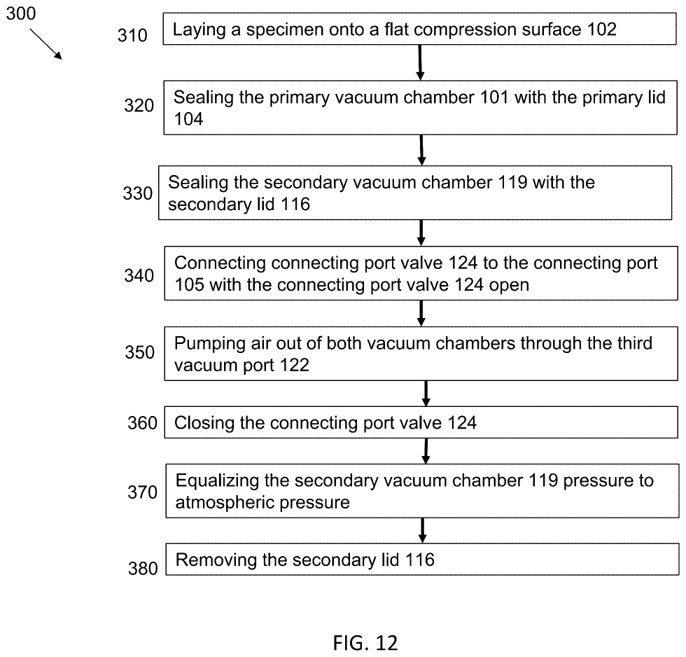

Reference is now made to FIG. 12. In some aspects, the invention relates to a method 300 of flattening a specimen using an embodiment of apparatus 100 with two vacuum chambers. In some embodiments, the method includes 310 laying a specimen onto a flat compression surface 102; 320 sealing the primary vacuum chamber 101 with the primary lid 104; 330 sealing the secondary vacuum chamber 119 with the secondary lid 116; 340 connecting port valve 124 to the connecting port 105 with the connecting port valve 124 open; 350 pumping air out of both vacuum chambers through the third vacuum port 122; 360 closing the connecting port valve 124; 370 equalizing the secondary vacuum chamber 119 pressure to atmospheric pressure; and 380 removing the secondary lid 116.

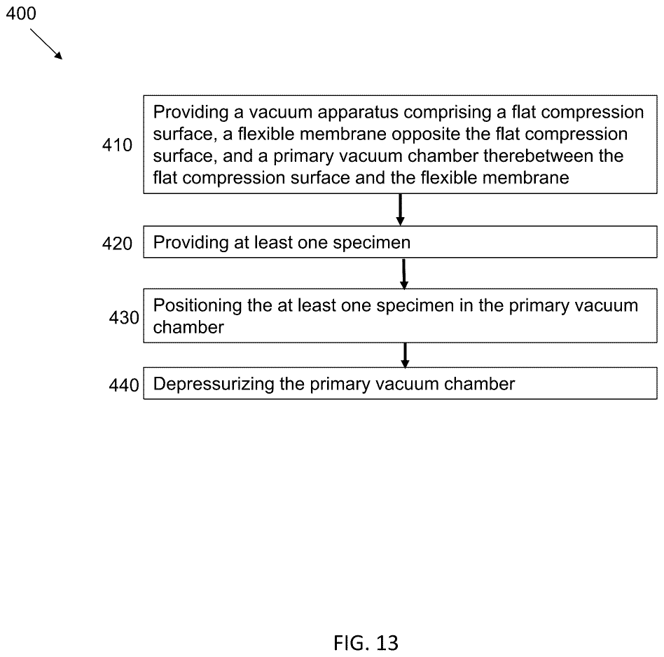

Reference is now made to FIG. 13. In some aspects, the invention relates to a method 400 of flattening a specimen, including the steps of 410 providing a vacuum apparatus comprising a flat compression surface, a flexible membrane opposite the flat compression surface, and a primary vacuum chamber therebetween the flat compression surface and the flexible membrane; 420 providing at least one specimen; 430 positioning the at least one specimen in the primary vacuum chamber; and 440 depressurizing the primary vacuum chamber.

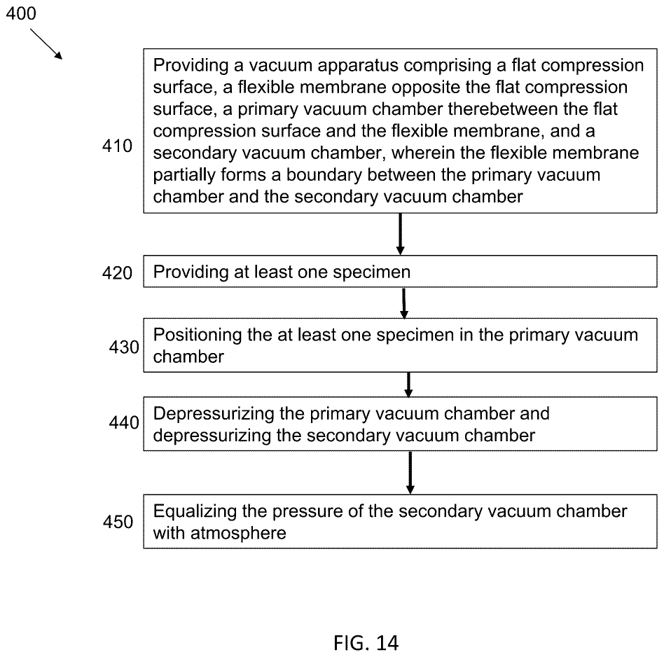

Reference is now made to FIG. 14. In some embodiments of the method 400, the vacuum apparatus of step 410 also includes a secondary vacuum chamber such that the flexible membrane at least partially forms a boundary between the primary vacuum chamber and the secondary vacuum chamber. In this embodiment of the method 400, step 440 also includes depressurizing the secondary vacuum chamber. This embodiment of the method 400 also includes the step of 450 equalizing the pressure of the secondary vacuum chamber with atmosphere. In some embodiments of the method 400, the vacuum apparatus of step 410 is any embodiment of the apparatus 100.

In some embodiments of the method 400, any specimen is provided. The specimen may be a tissue obtained from a subject. The specimen may be a biopsy, a tumor, a shave specimen, an excision, a surgical margin, an animal specimen, or other surgically removed tissue or histology. The specimen may be obtained during Mohs surgery for skin cancer. The specimen may be any size including any volume or dimensions. The specimen may be from a healthy or diseased subject. The specimen may be from an animal model organism or any genetically engineered model organism. The specimen may be a tissue excised from a subject. They specimen may be collected while any other surgery or procedure is performed on a subject.

In some embodiments, the specimen is positioned in the primary vacuum chamber by any method. The specimen may be positioned such that a surface of the specimen that is desired to be flattened is resting against the flat compression surface of the primary vacuum chamber. The specimen may be handled and positioned manually. The specimen may be positioned with the aid of any tools including forceps or holders. An operator may apply any pressure onto the specimen while it is being positioned to remove any bubbles or folds between the flat compression surface and the specimen. The specimen may be apportioned, cut, torn, or manipulated in any fashion before being positioned in the apparatus.

In some embodiments, the vacuum chambers of the device are depressurized using any method such as by the use of any vacuum pump. The vacuum chambers may be depressurized to reach any pressure below atmospheric pressure. For example, the vacuum chambers may be depressurized to reach a pressure of or of about 0.9 atm, 0.8 atm, 0.7 atm, 0.6 atm, 0.5 atm, 0.4 atm, 0.3 atm, 0.2 atm, 0.1 atm, 0.05 atm, or 0.01 atm. For example, the vacuum chambers may be depressurized to reach a pressure of less than or less than about 0.9 atm, 0.8 atm, 0.7 atm, 0.6 atm, 0.5 atm, 0.4 atm, 0.3 atm, 0.2 atm, 0.1 atm, 0.05 atm, or 0.01 atm. For example, the vacuum chambers may be depressurized to reach a pressure in the range of 0.01 atm to 0.9 atm. The vacuum chambers may be depressurized such that a pressure differential across the flexible membrane is any magnitude pressure differential. For example, the vacuum chambers may be depressurized such that a pressure differential across the flexible membrane is or is about 0.99 atm, 0.95 atm, 0.9 atm, 0.8 atm, 0.7 atm, 0.6 atm, 0.5 atm, 0.4 atm, 0.3 atm, 0.2 atm, or 0.1 atm. For example, the vacuum chambers may be depressurized such that a pressure differential across the flexible membrane is greater than or greater than about 0.99 atm, 0.95 atm, 0.9 atm, 0.8 atm, 0.7 atm, 0.6 atm, 0.5 atm, 0.4 atm, 0.3 atm, 0.2 atm, or 0.1 atm. For example, the vacuum chambers may be depressurized such that a pressure differential across the flexible membrane is in the range of 0.1 atm to 0.99 atm. In some embodiments, the external pressure against the flexible membrane is atmospheric pressure and the internal pressure against the flexible membrane is the pressure of the depressurized vacuum chamber. In some embodiments, liquid is also removed during depressurization of the vacuum chambers. In some embodiments, a sensor is used to measure the pressure in the vacuum chambers in real time and a vacuum pump is operated to achieve the desired pressure. In some embodiments, a vacuum pump is operated by a programmable control. In some embodiments, a pressure sensor is in communication with a programmable control. In some embodiments, the vacuum chambers are depressurized at any rate.

In some embodiments, the secondary vacuum chamber is equilibrated with atmospheric pressure or otherwise repressurized after depressurization. The secondary vacuum chamber may be equilibrated with atmospheric pressure such that a pressure differential is generated across the flexible membrane. The secondary vacuum chamber pressure may be equilibrated by removal of the air tight seal in any fashion or through the release of an atmospheric valve. Air may be pumped into the secondary vacuum chamber to repressurize the chamber. A pressure sensor may be used to determine the internal pressure of the secondary vacuum chamber at any point and may aid in calibrating the secondary vacuum chamber to achieve the desired pressure. Equilibration or repressurizing may be gradual.

In some embodiments, the flattened specimen is manipulated through the flexible membrane by an operator. The flattened specimen may be manipulated to enhance uniform flattening, to remove any bubbles in between the flat compression surface and the specimen or otherwise near the specimen, to reveal obscured facets of the specimen, or to correct any undesired specimen folds or folding. The flexible membrane may be manipulated by hand by an operator. The flexible membrane may be poked, pressured, and/or rolled. The flexible membrane may be manipulated with the aid of a tool, for example forceps, a roller, a blotting roller, or a rolling pin.

In some embodiments, a subject is diagnosed based on the examination of the flattened specimen. The specimen may be a tissue obtained from a subject. The subject may be diagnosed with any disease or condition. The flattened surface of the specimen may be examined for any growths, discoloration, abnormalities, malignant tissue regions, and/or cancerous tissue regions. Any examination method used to score or determine the disease state of a tissue may be used. The flattened specimen may be examined through an at least partially optically transparent flat compression surface. The flattened specimen may be examined after removal from the primary vacuum chamber. The flattened specimen may be examined with the aid of a microscope, camera, or any imaging method.

Diagnosis of flattened specimens could be performed in a number of clinically important scenarios. For example, biopsies are often performed for diseases such as breast cancer, skin cancer, prostate cancer, colon cancer, head and neck cancer, thyroid cancer, stomach cancer among many others. In each of these conditions, one or more small biopsies is removed from the patient for examination. The present invention could be used to facilitate processing of small tissue biopsies for conventional histopathology or to flatten tissue in order to more efficiently perform real-time diagnosis during clinical procedures.

In some embodiments, the examination of the flattened specimen aids in performing a surgery. For example, the surgery may be a surgery to remove a cancerous tissue. The surgery may be a Mohs surgery for skin cancer. A tissue of a subject that is suspected to be cancerous may be removed from a subject. The tissue may then be flattened and the surface of the tissue may be examined. The examination of the tissue may aid in determining if all cancerous tissue has been removed from a patient. If the removed tissue is deemed to contain cancerous tissue, then more tissue may be removed from the subject and examined. Tissue may be removed and examined from a subject until cancerous tissue is no longer detected in the examined tissue after flattening. The surgery may be concluded when cancerous tissue is no longer detected in the examined tissue.

In some embodiments, a liquid solution is introduced to the primary vacuum chamber before or after the specimen is positioned in the primary vacuum chamber. For example, the liquid solution may be introduced and may fill the primary vacuum chamber before the specimen is flattened and may be removed from the chamber by the use of a pump. In some embodiments, the liquid solution may be contained in a reservoir within the apparatus and introduced through a port and may be drawn through the primary vacuum chamber with the aid of a vacuum pump. The liquid solution may aid in the preservation or fixing of the specimen or may aid in the imaging or visual inspection of the specimen. The liquid solution may include any fixative, any dye, any antibody for immunohistochemistry, any permeabilizer, and/or any fluorescent molecule. For example, the fluid may include a fixing solution, formalin, formaldehyde, paraformaldehyde, methanol, a buffer, saline, a permeabilization solution, a detergent, an antibody, a fluorescent molecule, an imaging stain, DAPI, Hoechst, acridine, and/or eosin. In some examples, any liquids are introduced sequentially to the primary vacuum chamber and the positioned specimen. Any wash or buffer solutions may be introduced in between the introduction of a fixative and a staining solution for example.

In some embodiments, the specimen may be preserved after it is flattened. In some embodiments, the specimen is preserved by freezing. The flat compression surface that contacts the specimen may be thermally conductive. The use of an external heat extractor, an internal heat extractor, or a thermoelectric cooler may aid in cooling the apparatus to promote specimen freezing. In some embodiments, the primary vacuum chamber of the apparatus or the whole apparatus may be placed in a refrigerator, in a freezer, in liquid nitrogen, on dry ice, or in an otherwise cold environment.

In some embodiments, the specimen is removed from the primary vacuum chamber after it is flattened and made rigid through freezing or chemical fixation. It may then be sectioned into histology slides. Sectioning may be performed using any method including cryosectioning or paraffin sectioning.

In some embodiments, the specimen is imaged through the flat compression surface or after it is removed from the flat compression surface. In some embodiments, the imaging is aided by the use of any microscope. In some embodiments, the specimen is imaged in real time as it is being flattened. In some embodiments, the specimen is imaged using fluorescence microscopy, for example after a fluorescent molecule has been introduced to the specimen or after immunohistochemistry has been performed on the specimen. Any microscope may be used including a light microscope, a widefield microscope, a two-photon microscope, or a confocal microscope.

In some embodiments, valves, sensors including pressure sensors, vacuum pumps, imaging systems, cooling systems, liquid pumps, or any other aspects of the invention may be controlled by or through a computing device or may be in communication with a computing device including a microcontroller and/or a processor. For example, a microcontroller may be programmed to perform depressurizing steps and valve opening and closing steps according to a set program. In some embodiments, any valves may be control valves that are in communication with a processor. For example, one or more of the valves may be automated by computer or mechanical actuation, enabling simplified sequencing of the pressure within any vacuum chamber of the apparatus. In some examples, a user may need to only place a specimen or only initiate a preprogrammed specimen flattening protocol. The specimen flattening protocol may include any desired sequences of steps including achieving any desired pressures in any chamber in any order.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

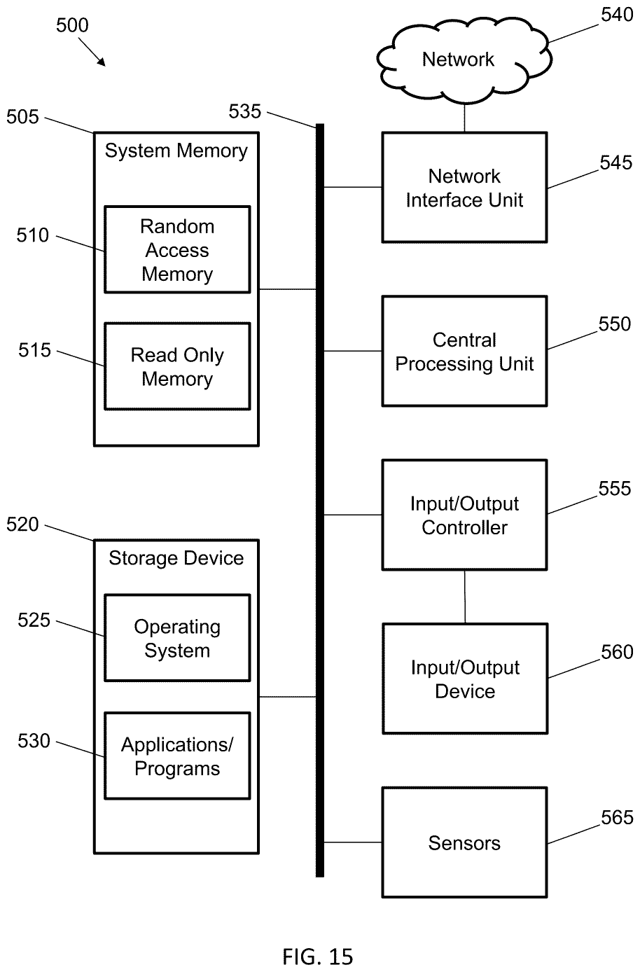

FIG. 15 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 15 depicts an illustrative computer architecture for a computer 500 for practicing the various embodiments of the invention. The computer architecture shown in FIG. 15 illustrates a conventional personal computer, including a central processing unit 550 (“CPU”), a system memory 505, including a random-access memory 510 (“RAM”) and a read-only memory (“ROM”) 515, and a system bus 535 that couples the system memory 505 to the CPU 550. A basic input/output system containing the basic routines that help to transfer information between elements within the computer, such as during startup, is stored in the ROM 515. The computer 500 further includes a storage device 520 for storing an operating system 525, application/program 530, and data.

The storage device 520 is connected to the CPU 550 through a storage controller (not shown) connected to the bus 535. The storage device 520 and its associated computer-readable media, provide non-volatile storage for the computer 500. Although the description of computer-readable media contained herein refers to a storage device, such as a hard disk or CD-ROM drive, it should be appreciated by those skilled in the art that computer-readable media can be any available media that can be accessed by the computer 500.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 500 may operate in a networked environment using logical connections to remote computers through a network 540, such as TCP/IP network such as the Internet or an intranet. The computer 500 may connect to the network 540 through a network interface unit 545 connected to the bus 535. It should be appreciated that the network interface unit 545 may also be utilized to connect to other types of networks and remote computer systems.

The computer 500 may also include an input/output controller 555 for receiving and processing input from a number of input/output devices 560, including a keyboard, a mouse, a touchscreen, a camera, a microphone, a controller, a joystick, or other type of input device. Similarly, the input/output controller 555 may provide output to a display screen, a printer, a speaker, or other type of output device. The computer 500 can connect to the input/output device 560 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 520 and RAM 510 of the computer 500, including an operating system 525 suitable for controlling the operation of a networked computer. The storage device 520 and RAM 510 may also store one or more applications/programs 530. In particular, the storage device 520 and RAM 510 may store an application/program 530 for providing a variety of functionalities to a user. For instance, the application/program 530 may comprise many types of programs such as a word processing application, a spreadsheet application, a desktop publishing application, a database application, a gaming application, internet browsing application, electronic mail application, messaging application, and the like. According to an embodiment of the present invention, the application/program 530 comprises a multiple functionality software application for providing word processing functionality, slide presentation functionality, spreadsheet functionality, database functionality and the like.

The computer 500 in some embodiments can include a variety of sensors 565 for monitoring the environment surrounding and the environment internal to the computer 500. These sensors 565 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore specifically point out exemplary embodiments of the present invention and are not to be construed as limiting in any way the remainder of the disclosure.

### Example 1: Single Vacuum Configuration Specimen Flattening Apparatus and Method

Balloon and piston compression devices have been used to flatten tissue to extract a flat plane for imaging. Balloon and piston compression devices apply a positive pressure to a balloon or piston filled with air or fluid which in turn compresses a specimen. Balloon and piston compression devices may use great amounts of force or may introduce folds into the flattened specimen.

Described in this example, is a single vacuum specimen flattening apparatus. The apparatus utilizes a single vacuum chamber to both remove excess fluid, including gas and liquid, and to compress the specimen using the negative differential pressure between the vacuum chamber and the atmosphere. As a result, this vacuum-based approach, compared to other methods, can obtain flatter tissue using less force while being much easier to correct problems in a flattened specimen such as folds. An additional advantage of the vacuum based approach compared to other methods is that the flexible membrane which compresses the tissue is accessible to a device operator who can manipulate the membrane to remove any folds, bubbles, or any undesirable specimen shapes. Additionally, force is applied to the specimen without deflecting the flat compression surface, avoiding distortion of the flat compression surface.

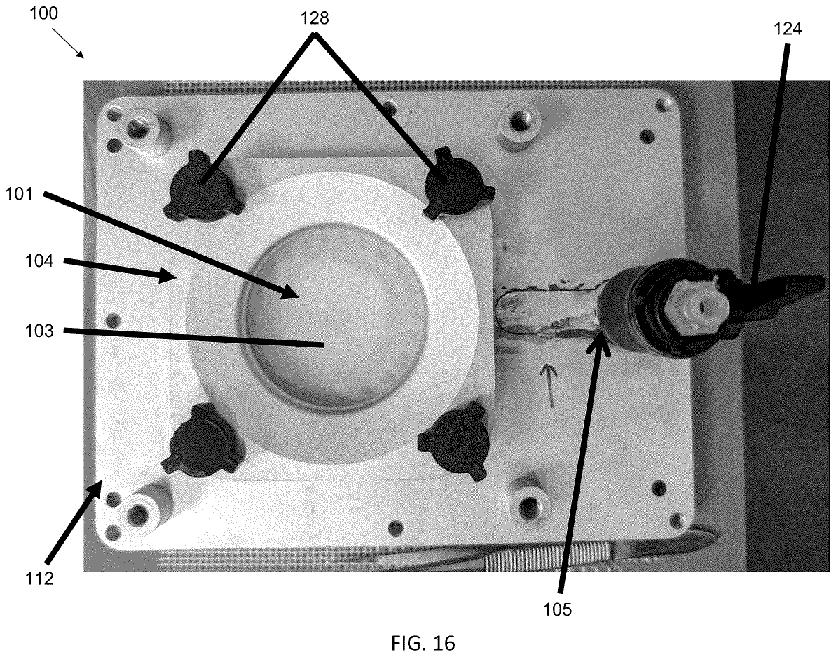

FIG. 16 is a top down view of a base 112 and applied primary lid 104 of an exemplary embodiment of a vacuum apparatus 100 before the primary vacuum chamber 101 is depressurized. The applied primary lid 104 generates an air tight seal against the base 112. The primary lid 104 is secured to the base by the use of primary lid thumb screws 128. The primary lid 104 contains a flexible membrane 103. A specimen is positioned within the primary vacuum chamber 101, but is not compressed by the flexible membrane 103 because no depressurization has yet occurred. Therefore, no pressure differential exists across the flexible membrane 103. The connecting port valve 124 is positioned in a vacuum port 105 that is fluidly connected to the primary vacuum chamber 101. A secondary vacuum chamber 119, is not present in this Example. The connecting port valve 124 may be connected to a vacuum pump 106 to depressurize the primary vacuum chamber 101, but is not currently connected.

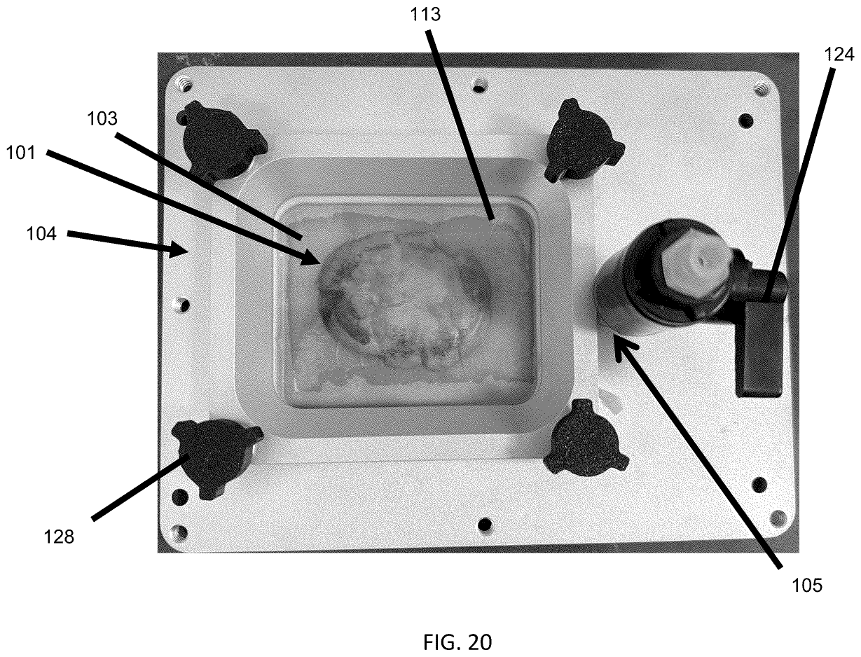

FIG. 20 is a top view of a fully compressed specimen through the flexible membrane 103 of an exemplary embodiment of an apparatus 100 with a single vacuum chamber. This embodiment utilizes a flexible membrane 103 with a large surface area such that a larger sized specimen may be compressed. A fluid wicking liner 113 is also included within the primary vacuum chamber 101. The fluid wicking liner 113 is visible as a white sheet that is visibly wet with extracted fluid. The connecting port valve 124 closes the vacuum port 105 therefore generating an airtight primary vacuum chamber 101. This embodiment includes easily accessed space around the flexible membrane to allow the user to quickly reach in and manipulate tissue. A vacuum pump may be connected to a connecting port valve 124 to further depressurize the primary vacuum chamber 101.

### Example 2: Double Vacuum Configuration Specimen Flattening Apparatus and Method

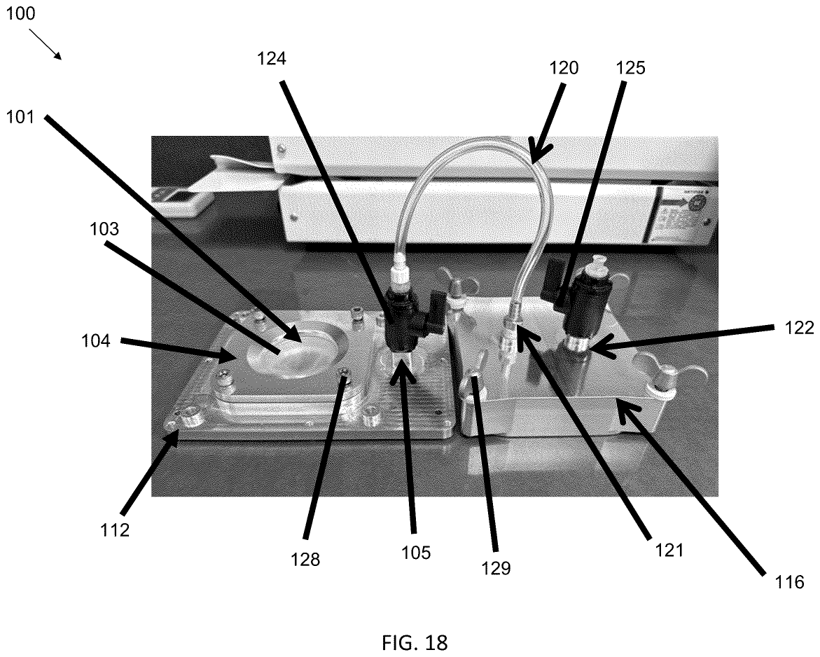

FIG. 18 is an oblique view of an exemplary embodiment of the vacuum apparatus 100 in the double vacuum configuration. A fluid connection exists between the primary vacuum chamber 101 and the secondary vacuum chamber 119 through secondary vacuum conduit 120 and the connecting port valve 124. In this instance, the secondary lid 116 that forms the secondary vacuum chamber 119 has been removed from the base 112 to reveal the flexible membrane 103 and enable inspection of the inner aspects of the example. A vacuum pump 106 could be connected to the third vacuum port 122 through the atmospheric valve 125. The closing of the connecting port valve 124 disrupts the fluid connection between both vacuum chambers after both chambers have been evacuated. The pressure differential across the flexible membrane 103 between atmosphere and the internal pressure of the primary vacuum chamber 101 drives the compression of the specimen by the flexible membrane 103.

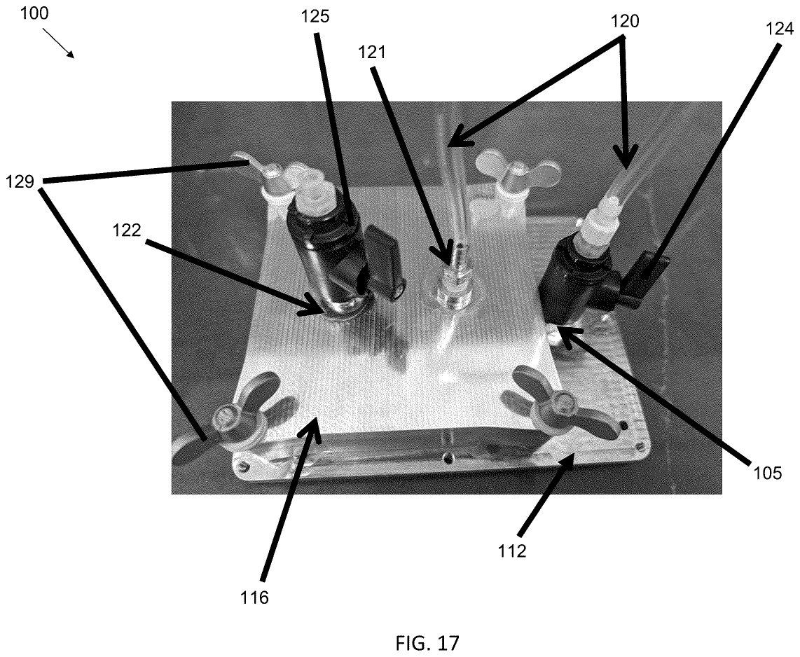

FIG. 17 is an oblique view of the exemplary embodiment of the vacuum apparatus 100 of FIG. 18 after the secondary lid 116 is applied to the base 112 over the top of the primary lid 104. The secondary vacuum port 121 is fluidly connected to the vacuum port 105 through the secondary vacuum conduit 121 and the connecting port valve 124 such that the primary vacuum chamber 101 and the secondary vacuum chamber 116 are fluidly connected. In this embodiment, the secondary vacuum conduit 120 is a thin tube. The connecting port valve 124 is initially open such that the secondary vacuum chamber 119 and the primary vacuum chamber 101 are fluidly connected through the secondary vacuum conduit 120. The atmospheric valve 125, which is applied to a third vacuum port 122, is also initially open so that the secondary lid 116 can be more easily applied to the base 112. The secondary lid 116 is secured to the base 112 by use of secondary lid thumb screws 129. The application of the secondary lid 116 to the base 112 over the top of the primary lid 104 generates an airtight seal. A vacuum pump 106 may be fluidly connected to the third vacuum port 122 and both valves may remain open such that the vacuum pump may depressurize the primary vacuum chamber 101 and the secondary vacuum chamber 119 concurrently. Following depressurization, the connecting port valve 124 may be closed, disrupting the fluid connection between the primary vacuum chamber 101 and the secondary vacuum chamber 119. Next the atmospheric valve 125 may be disconnected from the vacuum pump 106 and exposed to the atmosphere, equalizing the pressure in the secondary vacuum chamber 119. After equalization, the flexible membrane 103 will be compressed under the weight of the atmosphere onto the specimen and the flat compression surface.

An additional property of Example 2 is that it may be reduced to Example 1 by simply omitting the secondary lid 116 and connecting port 124 to a vacuum pump 106.

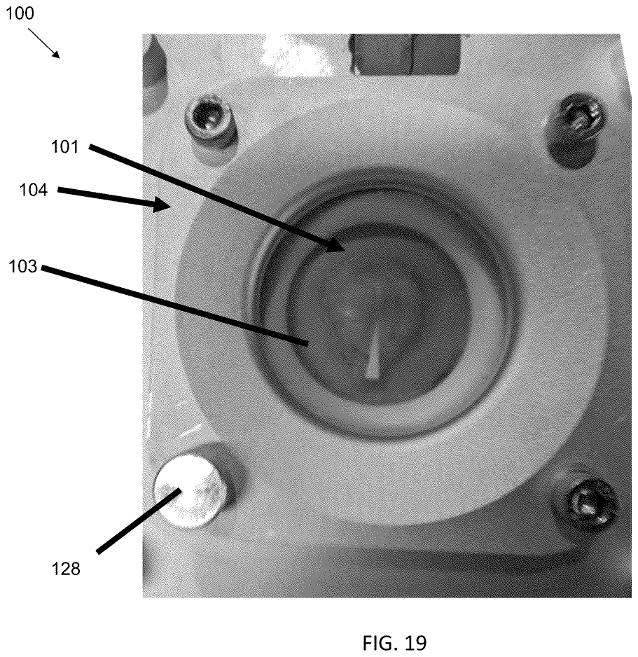

FIG. 19 is a top view of the compressed specimen through the flexible membrane 103 after the secondary lid 116 has been removed and the flexible membrane 103 exposed to atmospheric pressure. The positioned specimen is a surgically excised tissue. The primary vacuum chamber 101 is degassed. The flexible membrane 103 is compressing the positioned specimen such that the positioned specimen is flattened. The removal of the secondary lid 116 enables visualization of the flattened tissue through the optically transparent flexible membrane 103. The flexible membrane 103 can be manipulated by an operator directly by hand or with the aid of any tools to remove any undesired specimen folds, adjust tissue orientation, and/or adjust tissue flatness.

What is claimed is:

1. A specimen flattening apparatus comprising:
a base comprising a bottom floor comprising a flat compression surface configured to support a specimen;
a primary lid comprising a flexible membrane and a perimeter, wherein the primary lid is removably attached to the base via sealingly contacting the perimeter to the base such that the flexible membrane is opposite the flat compression surface, thereby forming a primary vacuum chamber bounded by the primary lid and the base; and
at least one vacuum pump connected to the primary vacuum chamber.

2. The apparatus of claim 1 further comprising:
a secondary lid comprising a top surface and a bottom opening forming a secondary cavity,
wherein the secondary lid is removably attached to the base enclosing the primary lid forming a seal at the bottom opening such that the secondary cavity forms a secondary vacuum chamber,
and wherein the flexible membrane forms at least part of a boundary between the primary vacuum chamber and the secondary vacuum chamber; and
at least one vacuum pump connected to the secondary vacuum chamber.

3. The apparatus of claim 1,
wherein the primary lid further comprises an enclosed cavity that forms a secondary vacuum chamber,
and wherein the flexible membrane forms at least part of a boundary between the primary vacuum chamber and the secondary vacuum chamber; and
further comprising at least one vacuum pump connected to the secondary vacuum chamber.

4. The apparatus of claim 1, further comprising a secondary vacuum chamber enclosing the base and the primary lid, wherein the secondary vacuum chamber comprises a sealable opening.

5. The apparatus of claim 1, wherein the base further comprises a vacuum port fluidly connected to the primary vacuum chamber.

6. The apparatus of claim 1, wherein the primary lid further comprises a retainer.

7. The apparatus of claim 2, wherein the primary vacuum chamber and the secondary vacuum chamber are fluidly connected through at least one port.

8. The apparatus of claim 1, further comprising at least one specimen positioned in the primary vacuum chamber on the flat compression surface.

9. The apparatus of claim 1, further comprising a fluid wicking liner positioned in the primary vacuum chamber.

10. The apparatus of claim 1, wherein the flat compression surface or the flexible membrane is at least partially optically transparent.

11. The apparatus of claim 1, wherein the flat compression surface is thermally conductive.

12. The apparatus of claim 1, wherein the flat compression surface comprises a material selected from the group consisting of: a metal, a glass, a plastic, a crystal, calcium fluoride glass, magnesium fluoride glass, and borosilicate glass.

13. The apparatus of claim 1, wherein the flexible membrane comprises a material selected from the group consisting of: rubber, silicone, latex, and plastic.

14. The apparatus of claim 1, further comprising a microscope or a camera configured to image at least a portion of the cavity.

15. The apparatus of claim 1, further comprising a specimen divider extending into the primary vacuum chamber from the flat compression surface.

16. The apparatus of claim 1, further comprising a reservoir or port connected to the primary vacuum chamber configured to introduce fluid to the primary vacuum chamber.

17. The apparatus of claim 1, further comprising a pressure valve connected to the primary vacuum chamber.

18. The apparatus of claim 1, further comprising a temperature control component selected from the group consisting of: an external heat extractor, an internal heat extractor, and a thermoelectric cooler.

19. The apparatus of claim 1, further comprising a processor communicatively connected to the at least one vacuum pump.

20. The method of flattening a specimen comprising the steps of:
providing a vacuum apparatus comprising a flat compression surface, a flexible membrane opposite the flat compression surface, and a primary vacuum chamber therebetween the flat compression surface and the flexible membrane;
providing at least one specimen;
positioning the at least one specimen in the primary vacuum chamber on the flat compression surface; and
depressurizing the primary vacuum chamber.
